(19) United States
(12) Patent Application Publication
(10) Pub. No.: US 2024/0408487 A1
(43) Pub. Date: Dec. 12, 2024

(54) TEAM APPEARANCE CHANGING METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Biqi KE, Shenzhen (CN); Jiong Cai, Shenzhen (CN)

(21) Appl. No.: 18/810,329

(22) Filed: Aug. 20, 2024

Related U.S. Application Data
(63) Continuation of application No. PCT/CN2023/123235, filed on Oct. 7, 2023.

(30) Foreign Application Priority Data
Dec. 27, 2022 (CN) 202211691413.X

(51) Int. Cl. A63F 13/52; A63F 13/79

(52) U.S. Cl. CPC A63F 13/52; A63F 13/79

(57) ABSTRACT

This application discloses a team appearance changing method performed by a computer device. The method includes: displaying a team exhibition interface, the team exhibition interface comprising a plurality of player slots corresponding to a plurality of players belonging to a game team; displaying appearance information of the plurality of players in the game team on the plurality of player slots, wherein different players have different appearance information; and in response to a first player using a first function, displaying unified appearance information related to the first function on the plurality of player slots in replacement of the different appearance information corresponding to the plurality of players in the game team. Based on the foregoing solution, after the first function is used, the unified appearance information is displayed on the player slot corresponding to each player, so that interactive behavior costs and communication costs of the unified appearance information are reduced.

### CROSS-REFERENCE TO RELATED APPLICATIONS

This application is a continuation application of PCT Patent Application No. PCT/CN2023/123235, entitled “TEAM APPEARANCE CHANGING METHOD AND APPARATUS, DEVICE, MEDIUM, AND PROGRAM PRODUCT” filed on Oct. 7, 2023, which claims priority to Chinese Patent Application No. 202211691413.X, entitled “TEAM APPEARANCE CHANGING METHOD AND APPARATUS, DEVICE, MEDIUM, AND PROGRAM PRODUCT” filed on Dec. 27, 2022, both of which are incorporated herein by reference in their entirety.

### FIELD OF THE TECHNOLOGY

Embodiments of this application relate to the field of human-computer interaction, and in particular, to a team appearance changing method and apparatus, a device, a medium, and a program product.

### BACKGROUND OF THE DISCLOSURE

In various types of games, team cooperation games are gradually increasing. Such games require players to form a game team before the game starts and work together to play the game.

During the game, the players in the game team cooperate as a team. To improve team cooperation skills, a plurality of players belonging to the same game team may create a group atmosphere through unification of appearance information.

However, the players often encounter a situation where a player cannot clearly learn appearance information of another player even after repeated communications. Therefore, a team appearance changing method that reduces communication costs is needed.

### SUMMARY

This application provides a team appearance changing method and apparatus, a device, a medium, and a program product. The technical solutions are as follows:

According to an aspect of embodiments of this application, a team appearance changing method is performed by a computer device, and the method includes:

displaying a team exhibition interface, the team exhibition interface comprising a plurality of player slots corresponding to a plurality of players belonging to a game team;

displaying appearance information of the plurality of players in the game team on the plurality of player slots, wherein different players have different appearance information; and

in response to a first player using a first function, displaying unified appearance information related to the first function on the plurality of player slots in replacement of the different appearance information corresponding to the plurality of players in the game team.

According to another aspect of the embodiments of this application, a computer device is provided. The computer device includes:

a processor;

a transceiver connected to the processor; and

a memory, configured to store executable instructions of the processor,

the processor being configured to load and execute the executable instructions and cause the computer device to implement the team appearance changing method as described in the foregoing aspect.

According to another aspect of the embodiments of this application, a non-transitory computer-readable storage medium is provided, having at least one instruction, at least one program, a code set, or an instruction set stored therein, the at least one instruction, the at least one program, the code set, or the instruction set being loaded and executed by a processor of a computer device and causing the computer device to implement the team appearance changing method as described in the foregoing aspect.

Through the method for displaying the unified appearance information on the player slot corresponding to each game account in the game team by using the first function by the first game account, interactive behavior costs and communication costs of displaying the unified appearance information for the game team are reduced, and convenience of displaying the unified appearance information for the game team is improved. In addition, the method for changing the unified appearance information may further enhance a group atmosphere of the game team, thereby improving user experience.

### BRIEF DESCRIPTION OF THE DRAWINGS

FIG. 1 is a schematic diagram of a computer system according to an exemplary embodiment of this application.

FIG. 2 is a schematic diagram of a team appearance changing method according to an exemplary embodiment of this application.

FIG. 3 is a flowchart of a team appearance changing method according to an exemplary embodiment of this application.

FIG. 4 is a flowchart of a team appearance changing method according to an exemplary embodiment of this application.

FIG. 5 is a flowchart of a team appearance changing method according to an exemplary embodiment of this application.

FIG. 6 is a flowchart of a team appearance changing method according to an exemplary embodiment of this application.

FIG. 7 is a flowchart of a team appearance changing method according to an exemplary embodiment of this application.

FIG. 8 is a flowchart of a team appearance changing method according to an exemplary embodiment of this application.

FIG. 9 is a flowchart of a team appearance changing method according to an exemplary embodiment of this application.

FIG. 10 is a schematic diagram of a team appearance changing method according to an exemplary embodiment of this application.

FIG. 11 is a flowchart of a team appearance changing method according to an exemplary embodiment of this application.

FIG. 12 is a schematic diagram of a team appearance changing method according to an exemplary embodiment of this application.

FIG. 13 is a flowchart of a team appearance changing method according to an exemplary embodiment of this application.

FIG. 14 is a schematic diagram of a team appearance changing method according to an exemplary embodiment of this application.

FIG. 15 is a flowchart of a team appearance changing method according to an exemplary embodiment of this application.

FIG. 16 is a flowchart of setting a team soul card according to an exemplary embodiment of this application.

FIG. 17 is a flowchart of using a team soul card according to an exemplary embodiment of this application.

FIG. 18 is a flowchart of a team appearance changing method according to an exemplary embodiment of this application.

FIG. 19 is a block diagram of a team appearance changing apparatus according to an exemplary embodiment of this application.

FIG. 20 is a block diagram of a team appearance changing apparatus according to an exemplary embodiment of this application.

FIG. 21 is a schematic structural diagram of a terminal device or a network device according to an exemplary embodiment of this application.

### DESCRIPTION OF EMBODIMENTS

Object information (including but not limited to object device information, object personal information, and the like) and data (including but not limited to data configured for analysis, stored data, exhibited data, and the like) involved in this application are all information and data authorized by objects or fully authorized by all parties, and collection, use, and processing of relevant data need to comply with relevant laws, regulations, and standards of relevant countries and regions.

Some key terms in this application are briefly described below:

Multiplayer online battle arena (MOBA) game: It is a type of game in which a player may choose a type of character from various types of characters in which the player is skilled, and start a battle as two opposing teams. A condition for victory is to break through a defense line and destroy a building guarded by a rival player.

Interaction: It is communication and interaction, and refers to behaviors such as language communication and teaming formation of players in a game.

Game interface: It refers to a client interface of game software, including game design elements such as a button, an animation, a text, a sound, and a window in a game picture that come into direct or indirect contact with a player.

Game item: It is an article available to a player in a game, usually comes with a benefit or special ability, and may be selected by the player whether to use.

Communication cost: It is a conscious behavioral effort made by people on communication, including but not limited to time, money, and the like.

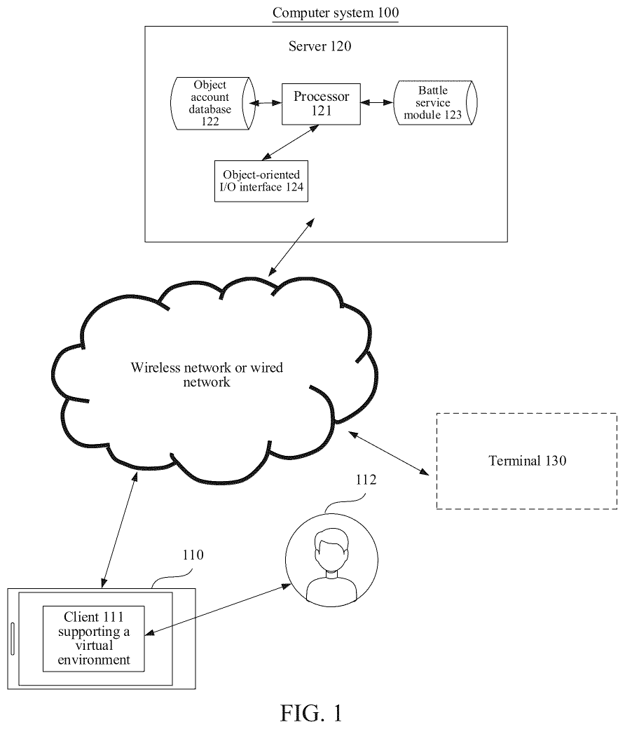

FIG. 1 is a schematic diagram of a computer system 100 according to an exemplary embodiment of this application. The computer system 100 includes a terminal 110 and a server 120.

The terminal 110 has a client 111 supporting a virtual environment installed and running therein. When the client 111 runs in the terminal 110, an object interface of the client 111 is displayed on a screen of the terminal 110. The client 111 may be any one of a multiplayer online battle program, a virtual reality (VR) application, an augmented reality (AR) program, a three-dimensional map program, a VR game, an AR game, a first-person shooting (FPS) game, a third-person shooting (TPS) game, and a MOBA game. The terminal 110 is a terminal used by a usage object 112.

The terminal 110 may generally refer to one of a plurality of terminals. In this embodiment, only the terminal 110 is used as an example for description. A device type of the terminal 110 includes at least one of a smartphone, a tablet computer, an e-book reader, a laptop portable computer, and a desktop computer.

FIG. 1 shows only one terminal. However, in a different embodiment, there are a plurality of terminals 130 that may be connected to the server 120. In some embodiments, one or more terminals 130 corresponding to a developer further exist. A development and editing platform of a client supporting a virtual environment is installed on the terminal 130. The developer may edit and update the client on the terminal 130, and transmit an updated client installation package to the server 120 through a wired or wireless network. The terminal 110 may download the client installation package from the server 120 to update the client.

The terminal 110 and the terminal 130 are connected to the server 120 through a wireless network or a wired network.

The server 120 includes at least one of one server, a plurality of servers, a cloud computing platform, and a virtualization center. The server 120 is configured to provide a backend service for the client 111. In some embodiments, the server 120 is in charge of primary computing work, and the terminal 110 is in charge of secondary computing work. Alternatively, the server 120 is in charge of secondary computing work, and the terminal 110 is in charge of primary computing work. Alternatively, a distributed computing architecture is used between the server 120 and the terminal 110 to perform collaborative computing.

In some embodiments, the server 120 includes a processor 121, an object account database 122, a battle service module 123, and an object-oriented input/output (I/O) interface 124. The processor 121 is configured to load instructions stored in the server 120, and process data in the object account database 122 and the battle service module 123. The object account database 122 is configured to store data of an object account used by each of the terminal 110 and the terminal 130, for example, an avatar of the object account, a name of the object account, a combat effectiveness index of the object account, and a service area where the object account is located. The battle service module 123 is configured to provide a plurality of battle rooms for objects to battle, for example, a 1V1 battle, a 3V3 battle, or a 5V5 battle. The object-oriented I/O interface 124 is configured to establish communication and exchange data with the terminal 110 and/or the terminal 130 through the wireless network or the wired network.

In various types of games, team cooperation games are gradually increasing. Such games require players to form a game team before the game starts and work together to play the game. During the game, the players in the game team cooperate as a team. To improve team cooperation skills, the players may create a group atmosphere by changing appearance information. However, the players often encounter a situation where a player cannot clearly learn appearance information of another player through communication a plurality of times. Therefore, a method for changing appearance information that reduces communication costs is needed.

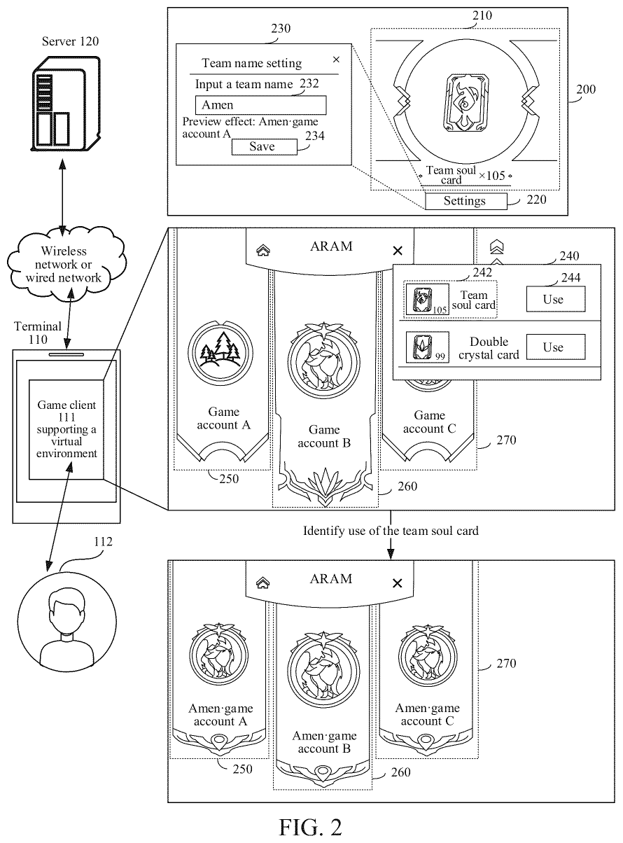

In this application, through unification of appearance information of a plurality of game accounts in the same game team, team cooperation enthusiasm of the players is increased, thereby improving team cooperation skills. Each game team includes at least two game members, and each game member corresponds to a game account. FIG. 2 is a schematic diagram of a team appearance changing method according to an exemplary embodiment of this application. The method is performed by a terminal 110 and a server 120.

The terminal 110 has a game client 111 supporting a virtual environment installed and running therein. The game client 111 reads different game parameters from a game interface. The game interface includes at least one of a team soul card setting interface 200, an item usage interface 240, a player slot 250 of a game account A, a player slot 260 of a game account B, and a player slot 270 of a game account C. The team soul card setting interface 200 includes at least one of a team soul card information interface 210, a team soul card setting key 220, and a team name setting interface 230.

In the case of preparation to start a game, a game process includes at least one of a battle preparation process, a battle loading process, and a battle fight process. The battle preparation process is a process from gathering the game account controlled by a player by a partner game team to starting loading game battle data. The battle loading process is a process from starting loading the game battle data to entering a game battle interface. The battle fight process is a process from entering the game battle interface to an end of a game battle.

Before a game is started or in a case that the game is in the battle preparation process, the player may control a game account to open the team soul card setting interface 200 to set a team name. Only the team name is set on the team soul card setting interface 200, and relevant appearance information controlled by a team soul card is set in an appearance system of the game account.

The team soul card information interface 210 is configured to exhibit an appearance of the team soul card and a quantity of team soul cards currently possessed. Exemplarily, the appearance of the team soul card is a card with a flame pattern, and a quantity of team soul cards currently possessed is 105.

The team soul card setting key 220 is configured to open the team name setting interface 230. After the player clicks/taps the team soul card setting key 220, the game interface displays the team name setting interface 230.

The team name setting interface 230 is configured to set a team name displayed before an account name. The team name setting interface 230 includes at least one of a team name input location 232 and a save key 234. After the team name is inputted in the team name input location 232, a preview effect of adding the team name before the account name is displayed on the team name setting interface 230. After the save key 234 is clicked/tapped, the team name is the set team name in a case that the team soul card is used. Exemplarily, the team name is set to Amen, and an original account name of the game account A is the game account A. A preview effect of the account name to which the team name is added is Amen•game account A.

In a case that the game is in the battle preparation process, the player uses an item through the item usage interface 240. The item usage interface 240 includes at least one of an item interface 242 and a usage key 244. An item icon, an item name, and a quantity of items currently possessed are exhibited on the item interface 242. Exemplarily, an item icon of the team soul card is a card with a flame pattern, and a quantity of team soul cards currently possessed is 105. An item icon of a double crystal card is a card with three diamond patterns, and a quantity of double crystal cards currently possessed is 99.

In a case that the game is in the battle preparation process, the player enters the team soul card setting interface 200 by clicking/tapping the team soul card icon, thereby setting the team name.

Content displayed on a player slot corresponding to the player includes at least one of an account avatar, an account avatar frame, an account flag, and an account name. Exemplarily, an account name displayed on the player slot 250 of the game account A is the game account A, and an account avatar, an account avatar frame, and an account flag corresponding to the game account A are displayed.

An account name displayed on the player slot 260 of the game account B is the game account B, and an account avatar, an account avatar frame, and an account flag corresponding to the game account B are displayed.

An account name displayed on the player slot 270 of the game account C is the game account C, and an account avatar, an account avatar frame, and an account flag corresponding to the game account C are displayed.

The team soul card may be used by a game account as a captain in a game team, or may be used by any game account. Exemplarily, if the game account B uses the team soul card as a captain of a game team, the item usage interface 240 automatically disappears after the team soul card is used.

In a case that the game client 111 identifies the use of the team soul card, the account name and appearance information of the game account are changed based on a preset team name and related appearance information of the game account that uses the team soul card, the team name and an interpunct are added before an account name of each game account as a team account name, and other appearance information of the game account is unified as the same appearance information.

Exemplarily, a team account name displayed on the player slot 250 of the game account A is Amen•game account A.

A team account name displayed on the player slot 260 of the game account B is Amen•game account B.

A team account name displayed on the player slot 270 of the game account C is Amen•game account C.

The same account avatar, the same account avatar frame, and the same account flag are displayed on the player slots of the three game accounts.

In some embodiments, in a case that the game is in the battle loading process, account names having the same team name, the same account avatar, and the same account role frame are displayed, and a corresponding background picture after the team soul card is used is displayed. The background picture includes a static picture and a dynamic effect.

In some embodiments, when the game is in a battle fight process, a corresponding broadcast message, a special effect animation, and the account names having the same team name after the team soul card is used are displayed on the game interface. The broadcast message is a system prompt message visible to the game accounts of both parties.

In some embodiments, in a case that the team account name includes a sensitive word, the game client 111 shields the team name. The sensitive word is related data information stored in the server. Exemplarily, a team account name of the game account B is Amen•game account B, and sensitive words in a game system include men B. The game client 111 uses asterisks to shield the team name, and finally displays the team account name of **•game account B, or Amen•**, or Ai *•* game account.

Based on the above, according to the method provided in this embodiment, after a game account in the game team uses the team soul card, the unified appearance information and the corresponding team account name are displayed on the player slot corresponding to each game account in the game team. In this way, interactive behavior costs and communication costs in the game team are reduced, and a group atmosphere of the game team is enhanced while improving convenience of displaying the unified appearance information of the game team, thereby improving user experience, and improving team cooperation skills.

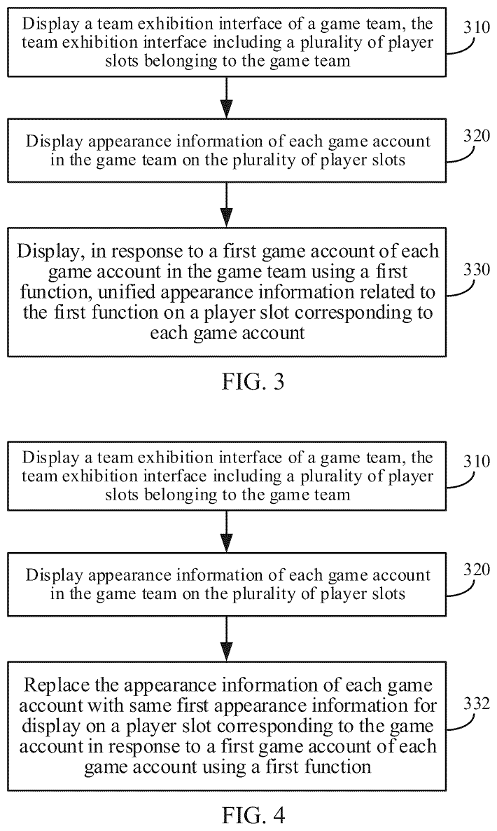

FIG. 3 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

Team cooperation games are a type of game that requires players to form a game team before the game is started and work together to complete a task after the game is started. The terminal displays a team exhibition interface of the game team. The team exhibition interface includes a plurality of player slots belonging to the game team, and is configured to exhibit content such as an account (Identity Document, ID) name, an account avatar, and an account level.

A player slot state includes an unoccupied state or an occupied state. In a case that no game account joins the game team, the player slot is in the unoccupied state. In a case that a game account joins the game team, a player slot corresponding to the game account is in the occupied state. Exemplarily, in a case that a quantity a of game accounts join the game team, a quantity a of player slots are in the occupied state, a being an integer greater than or equal to 1.

A player slot in the unoccupied state indicates that no game account enters the player slot, or may mean that no game account occupies the player slot. The unoccupied state is also referred to as an empty state, an out-of-use state, an idle state, or the like.

A player slot in the occupied state indicates that a game account enters the player slot, or may mean that a game account occupies the player slot. The occupied state is also referred to as a busy state, an in-use state, a player state, or the like.

Operation 320: Display appearance information of each game account in the game team on the plurality of player slots.

In some embodiments, in a case that no game account joins the game team, the player slot is in the unoccupied state, and the player slot is correspondingly displayed as a vacant image.

In some embodiments, in a case that a game account joins the game team, a player slot corresponding to the game account is in the occupied state, and the appearance information corresponding to each game account is displayed on each player slot in the occupied state.

The appearance information is performance content corresponding to a game account that is visible to a player, including at least one of an account avatar, an account flag, an account avatar frame, an account role frame, a background picture, and a birth mark. The account avatar is a picture representing an image of the game account in a network. The account flag is a background pattern of a flag style displayed behind the account avatar. The account avatar frame is a border pattern that decorates the account avatar. The account role frame is a border pattern that decorates an account character picture. The background picture is a background pattern displayed behind the player slot. The birth mark is a pattern displayed below the player slot.

Operation 330: Display, in response to a first game account of each game account in the game team using a first function, unified appearance information related to the first function on a player slot corresponding to each game account.

Each game account includes at least two game accounts. In response to the first game account of each game account in the game team using the first function, the unified appearance information related to the first function is displayed on the player slot corresponding to each game account.

The first function includes a first item or a first skill. The first item includes a specific quantity of virtual items possessed by the first game account. The first skill is a virtual function that may be used by the first game account in a case that a usage condition is met. The unified appearance information is obtained by the game account through customized editing by using the first function, or is generated by a server based on relevant information of the game account. The unified appearance information related to the first function includes at least one of the account avatar, the account flag, the account avatar frame, the account role frame, the background picture, and the birth mark.

Based on the above, according to the method provided in this embodiment, after the first game account uses the first function, the unified appearance information is displayed on the player slot corresponding to each game account in the game team. In this way, interactive behavior costs and communication costs of displaying the unified appearance information for the game team are reduced, convenience of displaying the unified appearance information for the game team is improved, and a group atmosphere of the game team is enhanced, thereby improving user experience, and improving team cooperation skills.

The game team in this application may refer to a game team formed by players through spontaneous team formation, or may refer to a game team formed by players through random matching, or may be an organization that includes a plurality of players, for example, a guild, or may be a plurality of players having an intimate relationship. The intimate relationship includes, for example, a friendship, a romantic relationship, a mentor-mentee relationship, a teammate relationship, brotherhood, and sisterhood.

FIG. 4 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

For relevant content, reference may be made to the operations described above, and details are not described herein again.

Operation 320: Display appearance information of each game account in the game team on the plurality of player slots.

For relevant content, reference may be made to the operations described above, and details are not described herein again.

Operation 332: Replace, in response to a first game account of each game account using a first function, the appearance information of each game account with same first appearance information for display on a player slot corresponding to the game account.

Each game account includes at least two game accounts. In response to the first game account of the at least two game accounts using the first function, the appearance information of each game account is replaced with the same first appearance information for display on the player slot corresponding to the game account.

Exemplarily, as shown in FIG. 2, in a case that the game account B serves as the first game account, and the team soul card serves as the first function, in response to the game account B using the team soul card, the appearance information of each game account is replaced with the same account avatar, the same account flag, and the same account avatar frame for display on the player slot corresponding to the game account.

The first appearance information is determined by a server authorized to use information in at least one of the following manners:

(1) Setting information of the first game account for the first function is obtained, and the first appearance information is determined based on appearance information preset by the server in a case that the setting information is blank information.

Exemplarily, in a case that the game account B serves as the first game account, and the team soul card serves as the first function, setting information of the game account B for the team soul card is obtained. In a case that the setting information of the team soul card is the blank information, it is determined based on the appearance information preset by the server that the first appearance information includes a first account avatar, a first account flag, and a first account avatar frame.

(2) Setting information of the first game account for the first function is obtained, and the first appearance information is determined based on the setting information in a case that the setting information is not the blank information.

Exemplarily, in a case that the game account B serves as the first game account, and the team soul card serves as the first function, setting information of the game account B for the team soul card is obtained. In a case that the setting information of the team soul card is not the blank information, it is determined based on the setting information that the first appearance information includes a corresponding account avatar, a corresponding account flag, and a corresponding account avatar frame set by the game account B.

In some embodiments, setting information of a second game account in the game team other than the first game account for the first function is obtained, and the first appearance information is determined based on the setting information in a case that the setting information is not the blank information.

Exemplarily, in a case that the game account B serves as the first game account, a game account C serves as the second game account, and the team soul card serves as the first function, setting information of the game account C for a team soul card thereof is obtained. In a case that the setting information of the team soul card is not the blank information, it is determined based on the setting information that the first appearance information includes a corresponding account avatar, a corresponding account flag, and a corresponding account avatar frame set by the game account C.

(3) Personal attribute information of the first game account is obtained, a quantity of times the appearance information has been used is identified from the personal attribute information, and the first appearance information is determined based on the appearance information that has been used a maximum quantity of times.

Exemplarily, in a case that the game account B serves as the first game account, personal attribute information of the game account B is obtained, and the quantity of times the appearance information has been used is identified from the personal attribute information. The first account avatar has been used 5 times, and a second account avatar has been used 10 times. The first account flag has been used twice, and a second account flag has been used 8 times. The first account avatar frame has been used once, and a second account avatar frame has been used 9 times. It is determined based on the appearance information that has been used the maximum quantity of times that the first appearance information includes the second account avatar, the second account flag, and the second account avatar frame.

In some embodiments, personal attribute information of each game account in the game team is obtained, a quantity of times the appearance information has been used is identified from the personal attribute information, and the first appearance information is determined based on the appearance information that has been used a maximum quantity of times. Quantities of times the same appearance information has been used are calculated through superposition.

Exemplarily, in a case that the game account B serves as the first game account, and the game account C serves as the second game account, personal attribute information of each of the game account B and the game account C is obtained, and a quantity of times the appearance information has been used is identified from the personal attribute information. The first account avatar has been used a total of 10 times, and the second account avatar has been used a total of 20 times. The first account flag has been used a total of 3 times, and the second account flag has been used a total of 9 times. The first account avatar frame has been used twice, and a second account avatar frame has been used a total of 12 times. It is determined based on the appearance information that has been used the maximum quantity of times that the first appearance information includes the second account avatar, the second account flag, and the second account avatar frame.

(4) The personal attribute information of the first game account is obtained, a usage time of the appearance information is identified from the personal attribute information, and the first appearance information is determined based on the appearance information with a longest usage time.

Exemplarily, in a case that the game account B serves as the first game account, personal attribute information of the game account B is obtained, and the usage time of the appearance information is identified from the personal attribute information. The first account avatar has been used for 5 days, and the second account avatar has been used for 10 days. The first account flag has been used for 2 days, and the second account flag has been used for 8 days. The first account avatar frame has been used for 1 day, and the second account avatar frame has been used for 9 days. It is determined based on the appearance information with the longest usage time that the first appearance information includes the second account avatar, the second account flag, and the second account avatar frame.

In some embodiments, personal attribute information of each game account in the game team is obtained, a usage time of the appearance information is identified from the personal attribute information, and the first appearance information is determined based on the appearance information with a longest usage time. Usage times of the same appearance information are calculated through superposition.

Exemplarily, in a case that the game account B serves as the first game account, and the game account C serves as the second game account, personal attribute information of each of the game account B and the game account C is obtained, and a usage time of the appearance information is identified from the personal attribute information. The first account avatar has been used for a total of 10 days, and the second account avatar has been used for a total of 20 days. The first account flag has been used for a total of 3 days, and the second account flag has been used for a total of 9 days. The first account avatar frame has been used for a total of 2 days, and the second account avatar frame has been used for a total of 12 days. It is determined based on the appearance information with the longest usage time that the first appearance information includes the second account avatar, the second account flag, and the second account avatar frame.

(5) The personal attribute information of the first game account is obtained, a usage time, a quantity of usage times, or a last usage type of the appearance information used by the first game account when participating in a game battle with other game accounts in a current game team together in the past is identified from the personal attribute information, and the first appearance information is determined based on the appearance information with the longest usage time, the maximum quantity of usage times, or the last usage type. Exemplarily, in a case that the game account B serves as the first game account, and the other game accounts in the current game team that participated in the game battle together in the past include the game account A, personal attribute information of the game account B is obtained. A usage time, a quantity of usage times, or a last usage type of the appearance information used by the game account B when participating in the game battle with the game account A together in the past is identified from the personal attribute information of the game account B.

In a case that the first appearance information is determined based on the appearance information with the longest usage time, the first account avatar has been used for 5 days, and the second account avatar has been used for 10 days. The first account flag has been used for 2 days, and the second account flag has been used for 8 days. The first account avatar frame has been used for 1 day, and the second account avatar frame has been used for 9 days. It is determined based on the appearance information with the longest usage time that the first appearance information includes the second account avatar, the second account flag, and the second account avatar frame.

In a case that the appearance information is determined based on the appearance information that has been used the maximum quantity of times, the first account avatar has been used 5 times, and the second account avatar has been used 10 times. The first account flag has been used twice, and a second account flag has been used 8 times. The first account avatar frame has been used once, and a second account avatar frame has been used 9 times. It is determined based on the appearance information that has been used the maximum quantity of times that the first appearance information includes the second account avatar, the second account flag, and the second account avatar frame.

In a case that the first appearance information is determined based on the appearance information of the last usage type, a last used account avatar is the second account avatar, a last used account flag is the second account flag, and a last used account avatar frame is the second account avatar frame, thereby determining that the first appearance information includes the second account avatar, the second account flag, and the second account avatar frame.

Based on the above, through the method provided in this embodiment, after the first game account uses the team soul card as the first function, the same first appearance information is displayed on the player slot corresponding to each game account in the game team. In this way, interactive behavior costs and communication costs in the game team are reduced, and a group atmosphere of the game team is enhanced, thereby improving user experience, and improving team cooperation skills.

According to the method provided in this embodiment, the first appearance information is further determined based on the appearance information preset by the server, based on the setting information, based on the appearance information that has been used the maximum quantity of times, based on the appearance information with the longest usage time, based on the appearance information used in the relevant game battle, or the like, thereby determining appropriate first appearance information based on different requirements.

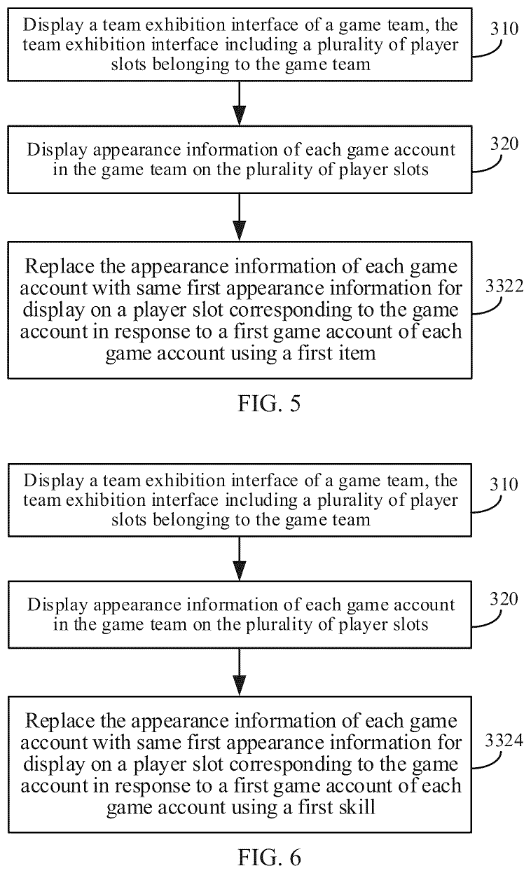

FIG. 5 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

For relevant content, reference may be made to the operations described above, and details are not described herein again.

Operation 320: Display appearance information of each game account in the game team on the plurality of player slots.

For relevant content, reference may be made to the operations described above, and details are not described herein again.

Operation 3322: Replace the appearance information of each game account with same first appearance information for display on a player slot corresponding to each game account in response to a first game account of each game account using a first item.

The first item includes a specific quantity of virtual items possessed by the first game account. In a case that a quantity of first items is not zero, in response to the first game account using the first item, the appearance information of each game account is replaced with the same first appearance information for display on the player slot corresponding to the game account.

Exemplarily, as shown in FIG. 2, in a case that the game account B serves as the first game account, and the team soul card serves as the first item, in response to the game account B using the team soul card, the appearance information of each game account is replaced with the same account avatar, the same account flag, and the same account avatar frame for display on the player slot corresponding to the game account.

Based on the above, through the method provided in this embodiment, after the first game account uses the first item, the same first appearance information is displayed on the player slot corresponding to each game account in the game team. In this way, interactive behavior costs and communication costs in the game team are reduced, and a group atmosphere of the game team is enhanced, thereby improving user experience, and improving team cooperation skills.

FIG. 6 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

For relevant content, reference may be made to the operations described above, and details are not described herein again.

Operation 320: Display appearance information of each game account in the game team on the plurality of player slots.

For relevant content, reference may be made to the operations described above, and details are not described herein again.

Operation 3324: Replace the appearance information of each game account with same first appearance information for display on a player slot corresponding to the game account in response to a first game account of each game account using a first skill.

The first skill is a virtual function that may be used by the first game account in a case that a usage condition is met. In a case that the usage condition is met, in response to the first game account using the first skill, the appearance information of each game account is replaced with the same first appearance information for display on the player slot corresponding to the game account.

Exemplarily, in a case that a game account B serves as the first game account, an appearance unification skill serves as the first skill, and the usage condition is that an account level of the game account B is 10, in response to the game account B using the appearance unification skill, the appearance information of each game account is replaced with the same account avatar, the same account flag, and the same account avatar frame for display on the player slot corresponding to the game account.

Based on the above, through the method provided in this embodiment, after the first game account uses the first skill, the same first appearance information is displayed on the player slot corresponding to each game account in the game team. In this way, interactive behavior costs and communication costs in the game team are reduced, and a group atmosphere of the game team is enhanced, thereby improving user experience, and improving team cooperation skills.

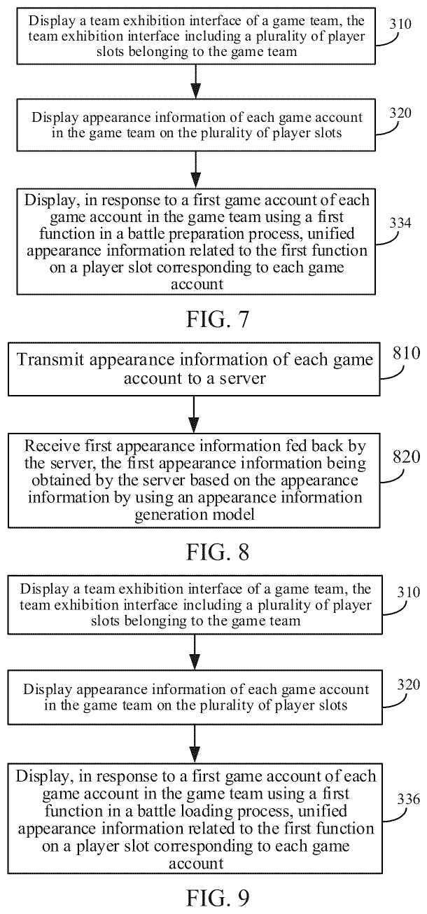

FIG. 7 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

For relevant content, reference may be made to the operations described above, and details are not described herein again.

Operation 320: Display appearance information of each game account in the game team on the plurality of player slots.

For relevant content, reference may be made to the operations described above, and details are not described herein again.

Operation 334: Display, in response to a first game account of each game account in the game team using a first function in a battle preparation process, unified appearance information related to the first function on a player slot corresponding to each game account.

A game process includes at least one of the battle preparation process, a battle loading process, and a battle fight process. The battle preparation process is a process from gathering game accounts controlled by players by a partner game team to starting loading game battle data. The battle loading process is a process from starting loading the game battle data to entering a game battle interface. The battle fight process is a process from entering the game battle interface to an end of a game battle. The unified appearance information displayed in different game processes may be different.

As shown in FIG. 2, in the battle preparation process, the game interface includes at least one of the item usage interface 240, the player slot 250 of the game account A, the player slot 260 of the game account B, and the player slot 270 of the game account C. Content displayed on a player slot of a game account includes at least one of an account avatar, an account avatar frame, an account flag, and an account name.

Exemplarily, an account name displayed on the player slot 250 of the game account A is the game account A, and an account avatar, an account avatar frame, and an account flag corresponding to the game account A are displayed.

An account name displayed on the player slot 260 of the game account B is the game account B, and an account avatar, an account avatar frame, and an account flag corresponding to the game account B are displayed.

An account name displayed on the player slot 270 of the game account Cis the game account C, and an account avatar, an account avatar frame, and an account flag corresponding to the game account C are displayed.

The item usage interface 240 includes at least one of an item interface 242 and a usage key 244. An item icon, an item name, and a quantity of items currently possessed are exhibited on the item interface 242. Exemplarily, an item icon of the team soul card serving as the first function is a card with a flame pattern, and a quantity of team soul cards currently possessed is 105. An item icon of a double crystal card is a card with three diamond patterns, and a quantity of double crystal cards currently possessed is 99.

The team soul card may be used by a game account as a captain in a game team, or may be used by any game account. Exemplarily, if the game account B uses the team soul card as a captain of a game team, the item usage interface 240 automatically disappears after the team soul card is used.

In response to the game account B using the team soul card, the appearance information of the game account is changed based on related appearance information preset by the game account B. Exemplarily, the same account avatar, the same account avatar frame, and the same account flag are displayed on the player slots of the three game accounts.

Based on the above, through the method provided in this embodiment, after the first game account uses the first function in the battle preparation process, the same first appearance information is displayed on the player slot corresponding to each game account in the game team. In this way, interactive behavior costs and communication costs in the game team are reduced, and a group atmosphere of the game team is enhanced, thereby improving user experience, and improving team cooperation skills.

FIG. 8 is a flowchart of a team appearance changing method according to an exemplary embodiment of this application. The method is performed by a terminal, and includes the following operations:

Operation 810: A terminal transmits appearance information of each game account to a server.

Each game account belongs to the same game team, including a first game account and a second game account.

The appearance information includes at least one of an account avatar, an account avatar frame, an account flag, a team name of a game team, a team profile of the game team, an account name card frame, an account birth mark, an account dynamic special effect, an account battle loading background, a key skin, a fight emblem, and an honorary title.

The dynamic special effect includes at least one of a special effect of recalling, a special effect of killing, a special effect of being attacked, a special effect of movement, a special effect of a skill, a special effect of death, a special effect of birth, a special effect of settlement, and the like.

Operation 820: Receive the first appearance information returned by the server, the first appearance information being obtained by the server based on the appearance information by using an appearance information generation model.

The first appearance information returned by the server includes at least one of a team account avatar, a team account avatar frame, a team account flag, a team name of the game team, a team account name card frame, a team account birth mark, a team account dynamic special effect, and a team account battle loading background.

The team account avatar is obtained by a server 120 based on the appearance information of the foregoing each game account by using a team account avatar generation model. The team account avatar frame is obtained by the server 120 based on the appearance information of the foregoing each game account by using a team account avatar frame generation model. The team account flag is obtained by the server 120 based on the appearance information of the foregoing each game account by using a team account flag generation model.

In some embodiments, the first appearance information displayed by the game team is obtained through an appearance information generation model. First appearance information generated by an appearance information generation model trained through one or more types of sample appearance information may include one or more types of appearance information.

In some embodiments, the types of the sample appearance information are the same as or different from the types of the first appearance information. Exemplarily, the types of the sample appearance information include an account avatar, an account avatar frame, an account flag, and a team name of the game team, and the types of the first appearance information include an account avatar, an account avatar frame, an account flag, a team name of the game team, an account dynamic special effect, an account battle loading background, and a key skin.

The appearance information generation model is trained in the following manners:

(1) Sample appearance information of a sample game team is obtained, the sample appearance information including at least one of account avatars of at least two accounts, account avatar frames of the at least two accounts, account flags of the at least two accounts, a team name of the game team, a team profile of the game team, account avatar frames of the at least two accounts, account name card frames of the at least two accounts, account birth marks of the at least two accounts, dynamic special effects of the at least two accounts, battle loading backgrounds of the at least two accounts, key skins of the at least two accounts, fight emblems of the at least two accounts, and honorary titles of the at least two accounts. At least two sample accounts include a first sample account.

The account avatar includes at least one of a current avatar, a historical avatar, an unlocked avatar, and a purchased avatar of an account. The avatar frame includes at least one of a current avatar frame, a historical avatar frame, an unlocked avatar frame, and a purchased avatar frame of the account. The flag includes at least one of a current flag, a historical flag, and an unlocked flag of the account.

(2) The sample appearance information is inputted into an information processing model, to obtain team appearance information. The information processing model is configured to process at least one of text information, image information, symbol information, color information, and animation information.

(3) An error loss between the team appearance information and team appearance information actually used by the sample game team is calculated.

(4) The information processing model is trained based on the error loss, to obtain the appearance information generation model.

In some embodiments, the first appearance information displayed by the game team is obtained through a plurality of appearance information generation models. The appearance information generation model trained through one or more types of sample appearance information is configured to generate a type of appearance information, and the first appearance information includes different types of appearance information generated by a plurality of appearance information generation models.

In some embodiments, the appearance information generation model includes at least one of the team account avatar generation model, the team account avatar frame generation model, the team account flag generation model, a team account birth mark generation model, a team account dynamic special effect generation model, and the like.

Exemplarily, the team account avatar generation model is used as an example. The team account avatar generation model is trained by the following manners:

(1) Sample appearance information of a sample game team is obtained, the sample appearance information including at least one of account avatars of at least two sample accounts, a team name of the sample game team, account names of the sample accounts, a team profile of the sample game team, avatar frames of the at least two sample accounts, flags of the at least two sample accounts, birth marks of the at least two sample accounts, and dynamic special effects of the at least two sample accounts. The at least two sample accounts include a first sample account.

The account avatar includes at least one of a current avatar, a historical avatar, an unlocked avatar, and a purchased avatar of an account. The avatar frame includes at least one of a current avatar frame, a historical avatar frame, an unlocked avatar frame, and a purchased avatar frame of the account. The flag includes at least one of a current flag, a historical flag, and an unlocked flag of the account.

Exemplarily, the sample game team includes a first sample account and a second sample account. An account avatar of the first sample account is an avatar of an account A, an account avatar of the second sample account is an avatar of an account B, the team name of the sample game team is Amen, an account name of the first sample account is a name of the account A, an account name of the second sample account is a name of an account B, and the team profile of the sample game team is victory.

(2) The sample appearance information is inputted into an image processing model, to obtain the team account avatar. Exemplarily, content such as the account avatars of the sample accounts, the team name of the sample game team, the account name of the sample accounts, the team profile of the sample game team, the avatar frames of the sample accounts, the account flags of the sample accounts, the birth marks of the sample accounts, the dynamic special effects of the sample accounts, and the battle loading backgrounds of the sample accounts described above is inputted into the image processing model, to obtain the team account avatar.

(3) An error loss between the team account avatar and a team account avatar actually used by the sample game team is calculated. Exemplarily, in the foregoing obtained team account avatar, the avatar of the account A and the avatar of the account B are placed side by side, the name of the account A and the name of the account B are correspondingly placed side by side below the two account avatars, the team name is placed below the two account names, and the team profile is placed above the two account avatars.

In the team account avatar actually used by the sample game team, the avatar of the account A and the avatar of the account B are placed side by side, the name of the account A and the name of the account B are correspondingly placed side by side below the two account avatars, the team name is placed below the two account names, and the team profile is placed below the team name. In the six pieces of sample appearance information, only a location of the team profile has an error, and therefore the error loss is 16.7%.

(4) The image processing model is trained based on the error loss, to obtain the team account avatar generation model. Exemplarily, through the training of the image processing model, in a case that the error loss is reduced to less than 5%, the team account avatar generation model is obtained.

Another appearance information generation model such as the team account avatar frame generation model, the team account flag generation model, the team account birth mark generation model, or the team account dynamic special effect generation model generates corresponding first appearance information based on sample appearance information of the same type or different types.

Exemplarily, the team account avatar frame generation model generates a team account avatar frame based on content such as the team name of the sample game team, a team keyword of the sample game team, and color information preset by the sample account. The team account avatar frame generation model is trained in the following manners:

(1) Sample appearance information of a sample game team is obtained, the sample appearance information including at least one of a team name of the sample game team, a team keyword of the sample game team, and color information preset by the sample account. The sample game team includes at least two sample accounts. Exemplarily, the sample game team includes a first sample account and a second sample account. The team name of the sample game team is Amen, the team keyword of the sample game team is dragon, color information preset by the first sample account is red, and color information preset by the second sample account is blue. The red preset by the first sample account as a captain of the game team is used as an example for description. In some embodiments, the color information preset by the second sample account or color information obtained through mixing color information preset by each sample account may also be used.

(2) The sample appearance information is inputted into an image processing model, to obtain the team account avatar frame. Exemplarily, content such as the team name of the sample game team, the team keyword of the sample game team, the color information preset by the sample account described above is inputted into the image processing model, to obtain the team account avatar frame.

(3) An error loss between the team account avatar frame and a team account avatar frame actually used by the sample game team is calculated. Exemplarily, in the foregoing obtained team account avatar frame, Amen corresponding to the team name is arranged above the team account avatar frame, dragon corresponding to the team keyword is arranged below the team account avatar frame, and a color of the team account avatar frame is red.

In the team account avatar frame actually used by the sample game team, Amen corresponding to the team name is arranged below the team account avatar frame, dragon corresponding to the team keyword is arranged above the team account avatar frame, and a color of the team account avatar frame is red. In the three pieces of sample appearance information, locations of the team name and the team keyword have errors, and therefore the error loss is 66.7%.

(4) The image processing model is trained based on the error loss, to obtain the team account avatar frame generation model. Exemplarily, through the training of the image processing model, in a case that the error loss is reduced to less than 5%, the team account avatar frame generation model is obtained.

Exemplarily, the team account flag generation model generates a team account flag based on content such as the team profile of the sample game team, an account avatar of a sample account, and color information preset by the sample account. The team account flag generation model is trained in the following manners:

(1) Sample appearance information of a sample game team is obtained, the sample appearance information including at least one of a team profile of the sample game team, an account avatar of a sample account, and color information preset by the sample account. The sample game team includes at least two sample accounts. Exemplarily, the sample game team includes a first sample account and a second sample account. The team profile of the sample game team is victory, an account avatar of the first sample account is an avatar of an account A, an account avatar of the second sample account is an avatar of an account B, color information preset by the first sample account is red, and color information preset by the second sample account is blue. The red preset by the first sample account as a captain of the game team is used as an example for description. In some embodiments, the color information preset by the second sample account or color information obtained through mixing color information preset by each sample account may also be used.

(2) The sample appearance information is inputted into an image processing model, to obtain the team account flag. Exemplarily, content such as the team profile of the sample game team, the account avatar of the sample account, the color information preset by the sample account described above is inputted into the image processing model, to generate the team account flag.

(3) An error loss between the team account flag and a team account flag actually used by the sample game team is calculated. Exemplarily, in the foregoing obtained team account flag, victory corresponding to the team profile is arranged above the team account flag, the account avatars corresponding to the first sample account and the second sample account are arranged side by side below the team account flag, and a color of the team account flag is blue.

In the team account flag actually used by the sample game team, victory corresponding to the team profile is arranged above the team account flag, the account avatars corresponding to the first sample account and the second sample account are arranged side by side below the team account flag, and a color of the team account flag is red. In the four pieces of sample appearance information, only the color of the team account flag has an error, and therefore the error loss is 25%.

(4) The image processing model is trained based on the error loss, to obtain the team account flag generation model. Exemplarily, through the training of the image processing model, in a case that the error loss is reduced to less than 5%, the team account flag generation model is obtained.

Another appearance information generation model such as a team account name card frame generation model, an account avatar frame generation model, a background picture generation model, a team account role frame generation model, a team account birth mark generation model, a team account battle loading background generation model, or a team account dynamic special effect generation model has the same training principle as the team account avatar generation model. Details are not described herein again.

Based on the above, according to the method provided in this embodiment, the appearance information generation model is trained based on the sample appearance information of the sample game team, thereby obtaining an appearance information generation model that meets a requirement, and increasing a possibility that automatically generated appearance information meets the requirement.

FIG. 9 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

For relevant content, reference may be made to the operations described above, and details are not described herein again.

Operation 320: Display appearance information of each game account in the game team on the plurality of player slots.

For relevant content, reference may be made to the operations described above, and details are not described herein again.

Operation 336: Display, in response to a first game account of each game account in the game team using a first function in a battle loading process, unified appearance information related to the first function on a player slot corresponding to each game account.

A game process includes at least one of the battle preparation process, the battle loading process, and a battle fight process. The battle preparation process is a process from gathering game accounts controlled by players by a partner game team to starting loading game battle data. The battle loading process is a process from starting loading the game battle data to entering a game battle interface. The battle fight process is a process from entering the game battle interface to an end of a game battle. The unified appearance information displayed in different game processes may be different.

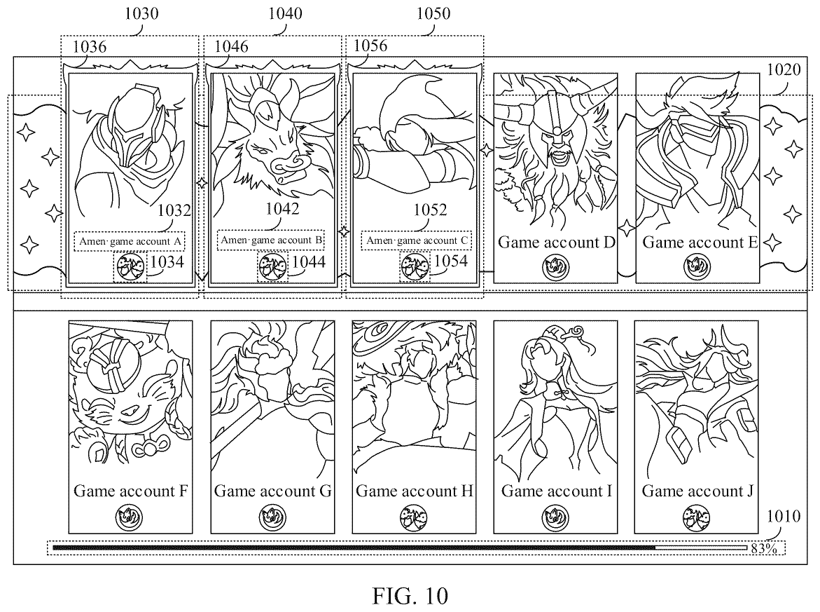

As shown in FIG. 10, in the battle loading process, the game interface includes at least one of a loading progress bar 1010, a background picture 1020, a first game account slot 1030, a second game account slot 1040, and a third game account slot 1050. A game account slot is a player slot corresponding to a game account. Content displayed on the game account slot includes at least one of an account name, an account avatar, and an account role frame.

Exemplarily, in response to a game account A using a team soul card, an account avatar 1034 of the game account A corresponding to the team soul card and an account role frame 1036 of the game account A are displayed on the first game account slot 1030.

An account avatar 1044 of the game account B corresponding to the team soul card and an account role frame 1046 of the game account B are displayed on the second game account slot 1040.

An account avatar 1054 of the game account C corresponding to the team soul card and an account role frame 1056 of the game account C are displayed on the third game account slot 1050.

The account avatars and the account role frames of the three game accounts are the same.

The loading progress bar 1010 represents a current game loading progress, and is displayed as a bar frame including a black part. A game loading progress value is correspondingly displayed on a right side, which is configured for indicating that the black part accounts for 0% to 100% of a length of the entire bar frame.

In a case that the loading progress value is 0%, a game enters the battle loading process, and starts loading game-related data.

In a case that the loading progress value is 100%, the game is about to enter the battle fight process.

The background picture 1020 is a picture displayed below the game account slot, including a static picture and a dynamic picture. Exemplarily, in a case that a game account in the game team above uses the team soul card, the background picture 1020 is displayed as a dynamic picture with twinkling stars.

Based on the above, through the method provided in this embodiment, after the first game account uses the first function in the battle loading process, the same first appearance information is displayed on the player slot corresponding to each game account in the game team. In this way, interactive behavior costs and communication costs in the game team are reduced, and a group atmosphere of the game team is enhanced, thereby improving user experience, and improving team cooperation skills.

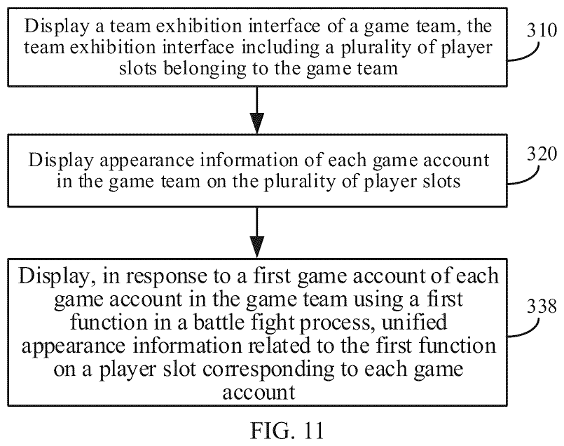

FIG. 11 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

For relevant content, reference may be made to the operations described above, and details are not described herein again.

Operation 320: Display appearance information of each game account in the game team on the plurality of player slots.

For relevant content, reference may be made to the operations described above, and details are not described herein again.

Operation 338: Display, in response to a first game account of each game account in the game team using a first function in a battle fight process, unified appearance information related to the first function on a player slot corresponding to each game account.

A game process includes at least one of a battle preparation process, a battle loading process, and the battle fight process. The battle preparation process is a process from gathering game accounts controlled by players by a partner game team to starting loading game battle data. The battle loading process is a process from starting loading the game battle data to entering a game battle interface. The battle fight process is a process from entering the game battle interface to an end of a game battle. The unified appearance information displayed in different game processes may be different.

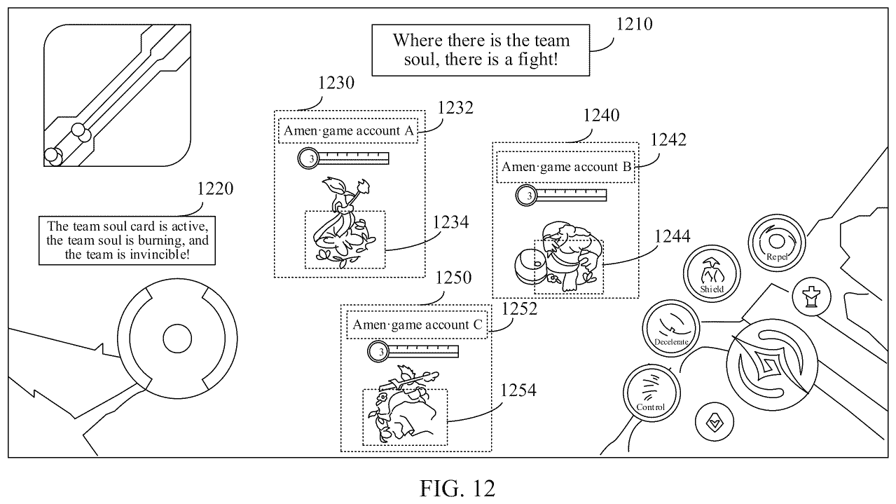

As shown in FIG. 12, in the battle fight process, the game interface includes at least one of a system broadcast region 1210, a chat region 1220, a first virtual character slot 1230, a second virtual character slot 1240, and a third virtual character slot 1250.

Each game account correspondingly controls a virtual character. A virtual character slot corresponding to the virtual character is a player slot corresponding to the game account. Information displayed on the virtual character slot includes at least one of an account name, a birth mark, a virtual character level, and a virtual character state. The birth mark is a pattern displayed below the virtual character slot, which is a static pattern or a dynamic pattern.

Exemplarily, in response to a game account A using a team soul card, a birth mark 1234 of the game account A corresponding to the team soul card is displayed on the first virtual character slot 1230,

a birth mark 1244 of the game account B corresponding to the team soul card is displayed on the second virtual character slot 1240, and a birth mark 1254 of a game account C corresponding to the team soul card is displayed on the third virtual character slot 1250.

The birth marks of the three game accounts are the same.

The system broadcast region 1210 is a region in which system prompt information transmitted by a game client to each game account is displayed. Exemplarily, in response to the game account A using the team soul card, system prompt information “where there is the team soul, there is a fight!” corresponding to the team soul card is displayed in the system broadcast region 1210.

The chat region 1220 is a region in which the game accounts perform text communication in the battle fight process, or a region in which the game client transmits a message. Exemplarily, in response to the game account A using the team soul card, a message “the team soul card is active, the team soul is burning, and the team is invincible!” transmitted by the game client is displayed in the chat region 1220.

Based on the above, through the method provided in this embodiment, after the first game account uses the first function in the battle fight process, the same first appearance information is displayed on the player slot corresponding to each game account in the game team. In this way, interactive behavior costs and communication costs in the game team are reduced, and a group atmosphere of the game team is enhanced, thereby improving user experience, and improving team cooperation skills.

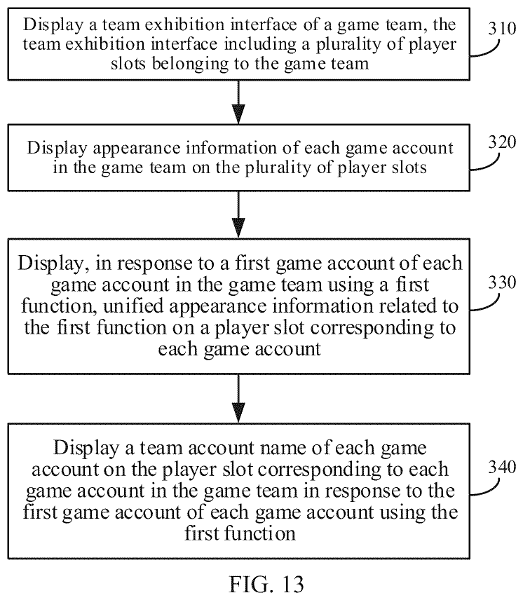

FIG. 13 is a flowchart of a team appearance changing method according to an exemplary embodiment of this application. The method is performed by a terminal, and includes the following operations:

Operation 310: Display a team exhibition interface of a game team, the team exhibition interface including a plurality of player slots belonging to the game team.

For relevant content, reference may be made to the operations described above, and details are not described herein again.

Operation 320: Display appearance information of each game account in the game team on the plurality of player slots.

For relevant content, reference may be made to the operations described above, and details are not described herein again.

Operation 330: Display, in response to a first game account of each game account in the game team using a first function, unified appearance information related to the first function on a player slot corresponding to each game account.

For relevant content, reference may be made to the operations described above, and details are not described herein again.

Operation 340: Display a team account name of each game account on the player slot corresponding to each game account in the game team in response to the first game account of each game account using the first function.

In different game processes, in response to the first game account of each game account using the first function, the team account name of each game account is displayed. A game process includes at least one of a battle preparation process, a battle loading process, and a battle fight process. The battle preparation process is a process from gathering the game account controlled by a player by a partner game team to starting loading game battle data, including a matching stage and a role selection stage. In the matching stage, the partner game team gathers the game account controlled by the player. In the role selection stage, the game account controlled by the player selects a virtual character to be used in the battle fight process.

### Battle Preparation Process

In the matching stage of the battle preparation process, as shown in FIG. 2, the game interface includes at least one of the item usage interface 240, the player slot 250 of the game account A, the player slot 260 of the game account B, and the player slot 270 of the game account C.

Exemplarily, in response to the game account B using the team soul card, the account name of the game account is changed based on a team name preset by the game account B. The team name and an interpunct are added before an account name of each game account to form a team account name. A team account name displayed on the player slot 250 of the game account A is Amen•game account A.

A team account name displayed on the player slot 260 of the game account B is Amen•game account B.

A team account name displayed on the player slot 270 of the game account C is Amen•game account C.

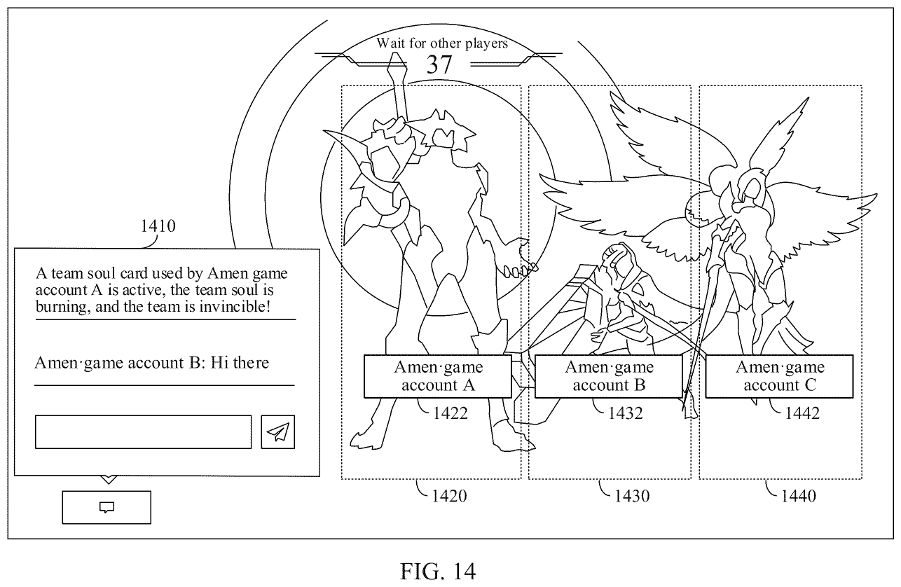

In the role selection stage of the battle preparation process, as shown in FIG. 14, the game interface includes at least one of a message region 1410, a first player slot 1420, a second player slot 1430, and a third player slot 1440.

Exemplarily, in response to the game account A using a team soul card, an account name 1422 of the game account A displayed on the first player slot 1420 is Amen•game account A.

An account name 1432 of the game account B displayed on the second player slot 1430 is Amen•game account B.

An account name 1442 of the game account C displayed on the third player slot 1440 is Amen•game account C.

In a case that the game account A uses the team soul card, relevant information is displayed in the message region 1410, for example, the team soul card used by the Amen•game account A has been active, the team soul is burning, and the team is invincible. Moreover, when each game account transmits a message in the message region 1410, the account name is displayed as the team account name. An example in which the game account B transmits a message “Hi there” is used. “Amen•game account B: Hi there.” is displayed in the message region 1410.

### Battle Loading Process

The battle loading process is a process from starting loading the game battle data to entering a game battle interface.

In the battle loading process, as shown in FIG. 10, the game interface includes at least one of a loading progress bar 1010, a background picture 1020, a first game account slot 1030, a second game account slot 1040, and a third game account slot 1050.

Content displayed on a game account slot includes at least one of an account name, an account avatar, and an account role frame.

Exemplarily, in response to the game account A using a team soul card, an account name 1032 of the game account A displayed on the first game account slot 1030 is Amen•game account A.

An account name 1042 of the game account B displayed on the second game account slot 1040 is Amen•game account B.

An account name 1052 of the game account C displayed on the third game account slot 1050 is Amen•game account C.

### Battle Height Process

The battle fight process is a process from entering the game battle interface to an end of a game battle.

In the battle fight process, as shown in FIG. 12, the game interface includes at least one of a system broadcast region 1210, a chat region 1220, a first virtual character slot 1230, a second virtual character slot 1240, and a third virtual character slot 1250.

Each game account correspondingly controls a virtual character. Information displayed on a virtual character slot corresponding to the virtual character includes at least one of an account name, a birth mark, a virtual character level, and a virtual character state.

Exemplarily, in response to a game account A using a team soul card, an account name 1232 of the game account A displayed on the first virtual character slot 1230 is Amen•game account A.

An account name 1242 of the game account B displayed on the second virtual character slot 1240 is Amen•game account B.

An account name 1252 of the game account C displayed on the third virtual character slot 1250 is Amen•game account C.

In an exemplary implementation, operation 330 and operation 340 in this embodiment may be merged into one operation. In other words, a team account name of each game account in the game team and unified appearance information are displayed on the player slot corresponding to each game account in response to a first game account of each game account using a first function. In an exemplary implementation, an execution order of operation 330 and operation 340 in this embodiment may be adjusted based on an actual situation. For example, operation 330 is performed before operation 340, or operation 340 is performed before operation 330, or operation 330 and operation 340 are performed simultaneously.

Based on the above, through the method provided in this embodiment, after the first game account is supported to use the first function, the team account name of each game account and the unified appearance information are displayed on the player slot corresponding to each game account in the game team. In this way, interactive behavior costs and communication costs are reduced, and a group atmosphere of the game team is enhanced, thereby improving user experience, and improving team cooperation skills.

In addition, the first game account is supported to use the first function in the battle preparation process, the battle loading process, or the battle fight process, to display the team account name of each game account and the unified appearance information on the player slot corresponding to each game account. There are no restrictions on a scene in which displaying of the unified appearance information by the game team is triggered. In this way, flexibility of displaying the unified appearance information and the team account name is greatly improved, and requirements of the game team for displaying the unified appearance information in different battle scenes may be met, thereby improving user experience.

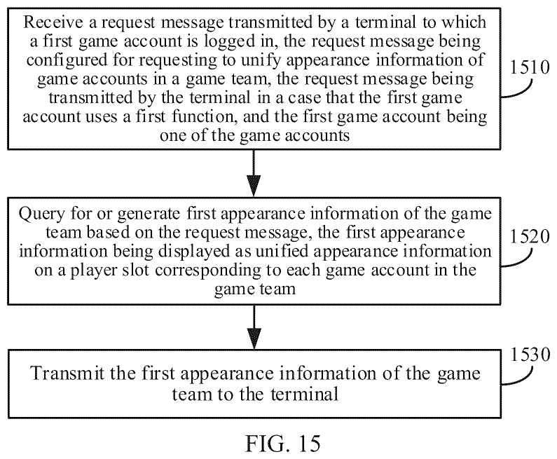

FIG. 15 is a flowchart of a team appearance changing method according to an exemplary embodiment of this application. The method is performed by a server, and includes the following operations:

Operation 1510: Receive a request message transmitted by a terminal to which a first game account is logged in, the request message being configured for requesting to unify appearance information of game accounts in a game team, the request message being transmitted by the terminal in a case that the first game account uses a first function, and the first game account being one of the game accounts.

Each game account includes the first game account and a second game account. The appearance information includes at least one of an account avatar, an account avatar frame, an account flag, a team name of a game team, and a team profile of the game team.

Operation 1520: Query for or generate first appearance information of the game team based on the request message, the first appearance information being displayed as unified appearance information on a player slot corresponding to each game account in the game team.

In some embodiments, first appearance information of the game team preset by the first game account is queried for based on the request message. Exemplarily, the first game account presets the first appearance information including an account avatar, an account avatar frame, an account flag, a team name of a game team, and a team profile of the game team.

In some embodiments, the first appearance information of the game team is generated based on the request message by using an appearance information generation model. The method includes: obtaining the appearance information of each game account in the game team based on the request message; and

inputting the appearance information into the appearance information generation model, to generate the first appearance information of the game team.

Exemplarily, the account avatar, the account avatar frame, the account flag, the team name of the game team, and the team profile of the game team of each of the first game account and the second game account are obtained based on the request message, and the foregoing appearance information is inputted into the appearance information generation model, thereby generating the first appearance information of the game team.

For specific implementation details of the appearance information generation model on a server side, reference may be made to the appearance information generation model on a terminal side, and details are not described herein again.

Operation 1530: Transmit the first appearance information of the game team to the terminal.

The server transmits the found or generated first appearance information of the game team to the terminal.

Based on the above, according to the method provided in this embodiment, the server receives the request message for unifying the appearance information transmitted by the terminal to which the first game account is logged in, thereby querying for or generating the first appearance information of the game team and transmitting the first appearance information to the terminal. In this way, interactive behavior costs and communication costs of the unified appearance information are reduced, and a group atmosphere of the game team is enhanced, thereby improving team cooperation skills.

According to the method provided in this embodiment, the appearance information generation model is further trained based on the sample appearance information of the sample game team, thereby obtaining an appearance information generation model that meets a requirement, and increasing a possibility that automatically generated appearance information meets the requirement.

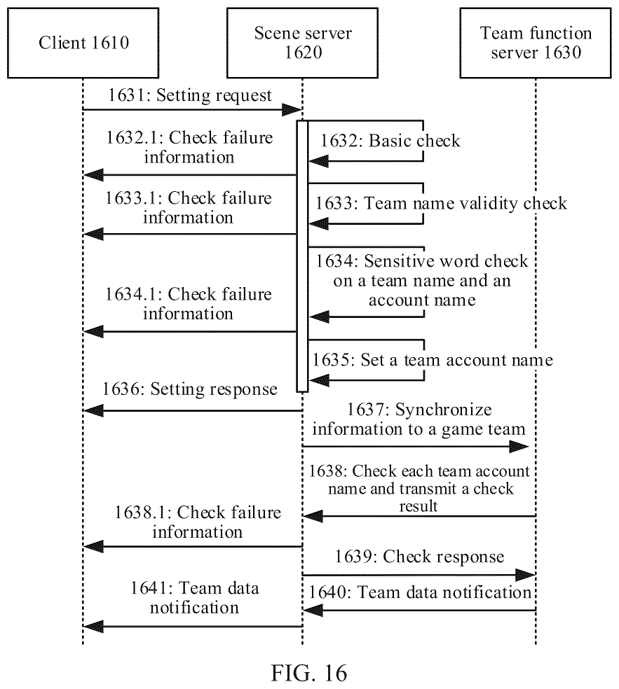

FIG. 16 is a flowchart of setting a team soul card according to an exemplary embodiment of this application. The method is performed by a client and a scene server, and includes the following operations:

Operation 1631: A client 1610 transmits a setting request.

In a case that related information of a team soul card needs to be set, the client 1610 transmits the setting request to a scene server 1620.

Operation 1632: The scene server 1620 performs a basic check.

The scene server 1620 performs the basic check. The basic check includes checking a current game state of the client 1610. The game state includes being not in a game process and being in the game process. The game process includes at least one of a battle preparation process, a battle loading process, and a battle fight process.

The team soul card may be used in a case of being not in a game process or in the battle preparation process, but cannot be used in the battle loading process and the battle fight process. In a case that the basic check fails, operation 1632.1 is performed. In a case that the basic check succeeds, operation 1633 is performed.

Operation 1632.1: The scene server 1620 transmits check failure information.

In a case that the basic check fails, the scene server 1620 transmits the check failure information to the client 1610, and the team soul card cannot be used.

Operation 1633: The scene server 1620 performs a team name validity check.

In a case that the basic check succeeds, the scene server 1620 performs the team name validity check. The validity check includes checking a field length of a team name. Exemplarily, in a case that the field length of the team name is set to no more than 6 characters, and the field length of the team name is 10 characters, the team name validity check fails.

In a case that the team name validity check fails, i.e., the field length of the team name does not meet the requirement, operation 1633.1 is performed. In a case that the team name validity check succeeds, i.e., the field length of the team name meets the requirement, operation 1634 is performed.

Operation 1633.1: The scene server 1620 transmits check failure information.

In a case that the team name validity check fails, the scene server 1620 transmits the check failure information to the client 1610, and the team soul card cannot be used.

Operation 1634: The scene server 1620 performs a sensitive word check on a team name and an account name.

In a case that the team name validity check succeeds, the scene server 1620 performs the sensitive word check on the team name and the account name. The sensitive word check includes at least one of checking whether the team name includes a sensitive word, checking whether the account name includes a sensitive word, and checking whether an account name with the team name added includes a sensitive word. Exemplarily, in a case that the team name includes a sensitive word “watergate”, the sensitive word check fails.

In a case that the sensitive word check fails, operation 1634.1 is performed. In a case that the sensitive word check succeeds, operation 1635 is performed.

Operation 1634.1: The scene server 1620 transmits check failure information.

In a case that the sensitive word check fails, the scene server 1620 transmits

the check failure information to the client 1610, and the team soul card cannot be used.

Operation 1635: The scene server 1620 sets a team account name.

In a case that the sensitive word check succeeds, the scene server 1620 sets the team account name based on the setting request transmitted by the client 1610. The team account name is an account name with the team name and an interpunct added. Exemplarily, if an account name of a game account A is game account A, and the team name is Amen, the team account name is Amen•game account A.

Operation 1636: The scene server 1620 transmits a setting response.

The scene server 1620 transmits the setting response to the client 1610, and the client 1610 completes setting of the team soul card. In a case that no game team exists, i.e., in a case of being not in a game process, a process of setting the team soul card ends. In a case that the game team exists, i.e., in a case of being in the game process, operation 1637 is performed.

Operation 1637: The scene server 1620 synchronizes information to a game team.

In a case that a game team exists, the scene server 1620 synchronizes the team account name to the game team. Exemplarily, in the battle preparation process in a case of being in the game process, the scene server 1620 sets an account name of each game account in the game team as the team account name.

Operation 1638: A team function server 1630 checks each team account name and transmits a check result.

The team function server 1630 performs an asynchronous check on validity and a sensitive word of each team account name, and transmits the check results to the scene server 1620. The check results of the team account names do not affect each other. In a case that a team account name check fails, operation 1638.1 is performed. In a case that the team account name check succeeds, operation 1639 is performed.

Operation 1638.1: The scene server 1620 transmits check failure information.

In a case that the scene server 1620 receives a team account name check result of failure, the scene server 1620 transmits the check failure information to the client 1610, and an account name of a corresponding game account is not displayed as the team account name.

Operation 1639: The scene server 1620 transmits a check response.

In a case that the scene server 1620 receives a check result of success, the scene server 1620 transmits the check response to the team function server 1630.

Operation 1640: The team function server 1630 transmits a team data notification.

The team function server 1630 transmits the team data notification to the scene server 1620. The team data notification includes the team account name.

Operation 1641: The scene server 1620 transmits the team data notification.

The scene server 1620 transmits the team data notification to the client 1610. The team data notification includes the team account name. The client 1610 displays the account name of each game account as the team account name.

Based on the above, through the method provided in this embodiment, after the team soul card is set in the battle preparation process or in a case of being not in a game process, to support a first game account to use the team soul card, the team account name of each game account is displayed on a player slot corresponding to each game account in the game team. In this way, interactive behavior costs and communication costs are reduced, and a group atmosphere of the game team is enhanced, thereby improving user experience, and improving team cooperation skills.

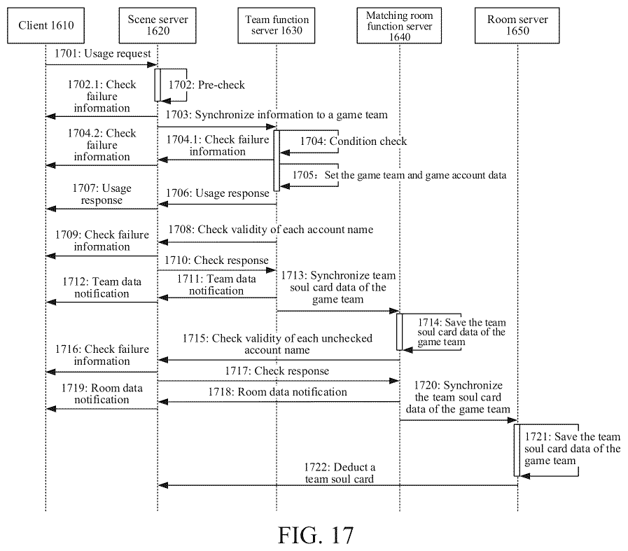

FIG. 17 is a flowchart of using a team soul card according to an exemplary embodiment of this application. The method is performed by a client and a scene server, and includes the following operations:

Operation 1701: A client 1610 transmits a usage request.

The client 1610 transmits the usage request to a scene server 1620, requesting to use a team soul card.

Operation 1702: The scene server 1620 performs a pre-check.

The scene server 1620 performs the pre-check. Check operations are shown in operation 1632 to operation 1635 in FIG. 16, and details are not described herein again. In a case that the pre-check fails, operation 1702.1 is performed. In a case that the pre-check succeeds, operation 1703 is performed.

Operation 1702.1: The scene server 1620 transmits check failure information.

In a case that the pre-check fails, the scene server 1620 transmits the check failure information to the client 1610, and the team soul card cannot be used.

Operation 1703: The scene server 1620 synchronizes information to a game team.

In a case that the game team exists, the scene server 1620 synchronizes team soul card information to the game team. Exemplarily, in the battle preparation process in a case of being in the game process, the scene server 1620 sets an account name of each game account in the game team as the team account name.

Operation 1704: A team function server 1630 performs a condition check.

The team function server 1630 performs the condition check. The condition check includes at least one of checking whether a quantity of players in the game team meets a usage conditions, and checking whether a game mode meets the usage condition. Exemplarily, the usage condition is the game team includes at least two players, and the game mode is not a ranking mode. The game mode includes at least one of an entertainment mode, a matching mode, and the ranking mode. The entertainment mode is a game mode in which virtual game resources cannot be obtained and game points cannot be accumulated. The matching mode is a game mode in which the virtual game resources may be obtained and the game points cannot be accumulated. The ranking mode is a game mode in which the virtual game resources may be obtained and the game points may be accumulated.

In a case that the condition check fails, operation 1704.1 is performed. In a case that the condition check succeeds, operation 1705 is performed.

Operation 1704.1: The team function server 1630 transmits check failure information.

In a case that the condition check fails, the team function server 1630 transmits the check failure information to the scene server 1620.

Operation 1704.2: The scene server 1620 transmits check failure information.

In a case that the condition check fails, the scene server 1620 transmits the check failure information to the client 1610, and the team soul card cannot be used.

Operation 1705: The team function server 1630 sets the game team and game account data.

In a case that the condition check succeeds, the team function server 1630 sets the game team and the game account data based on information about the team soul card. Exemplarily, the account name of each game account in the game team is set as the team account name.

Operation 1706: The team function server 1630 transmits a usage response.

The team function server 1630 transmits the usage response to the scene server 1620 after setting the game team and the game account data, indicating that the team soul card has been used.

Operation 1707: The scene server 1620 transmits the usage response.

The scene server 1620 receives the usage response transmitted by the team function server 1630, and then transmits the usage response to the client 1610. The client 1610 displays that the team soul card has been used.

Operation 1708: The team function server 1630 checks validity of each account name.

The team function server 1630 performs an asynchronous check on validity and a sensitive word of each account name, and transmits the check results to the scene server 1620. The check results of the account names do not affect each other. In a case that an account name check fails, operation 1709 is performed. In a case that the account name check succeeds, operation 1710 is performed.

Operation 1709: The scene server 1620 transmits check failure information.

In a case that a validity check of the account name fails, the scene server 1620 transmits the check failure information to the client 1610, and the team soul card cannot be used.

Operation 1710: The scene server 1620 transmits a check response.

The scene server 1620 transmits the check response to the team function server 1630, indicating that the validity check of the account name succeeds.

Operation 1711: The team function server 1630 transmits a team data notification.

The team function server 1630 transmits the team data notification to the scene server 1620 after receiving the check response. The team data notification includes each team account name.

Operation 1712: The scene server 1620 transmits the team data notification.

After the scene server 1620 receives the team data notification transmitted by the team function server 1630, the scene server 1620 transmits the team data notification to the client 1610, and the client 1610 displays the account name of each game account as the team account name.

Operation 1713: The team function server 1630 synchronizes team soul card data of the game team.

A game process includes at least one of a battle preparation process, a battle loading process, and a battle fight process. The battle preparation process is a process from gathering the game account controlled by a player by a partner game team to starting loading game battle data, including a matching stage and a role selection stage. In the matching stage, the partner game team gathers the game account controlled by the player. In the role selection stage, the game account controlled by the player selects a virtual character to be used in the battle fight process.

In a case that the game process proceeds to the matching stage of the battle preparation process, the team function server 1630 synchronizes the team soul card data of the game team to a matching room function server 1640, including the team account name and appearance information of each game account.

Operation 1714: The matching room function server 1640 stores the team soul card data of the game team.

The matching room function server 1640 receives the team soul card data of the game team transmitted by the team function server 1630, and then performs a saving operation on the team soul card data of the game team.

Operation 1715: The matching room function server 1640 checks validity of each unchecked account name.

During checking of the validity of the account name, since check results of all of the account names are not obtained timely due to reasons such as a network fluctuation, the matching room function server 1640 checks a game account without the check result again, and transmits a check result to the scene server 1620. In a case that an account name check fails, operation 1716 is performed. In a case that the account name check succeeds, operation 1717 is performed.

Operation 1716: The scene server 1620 transmits check failure information.

In a case that a validity check of the account name fails, the scene server 1620 transmits the check failure information to the client 1610, and the team soul card cannot be used.

Operation 1717: The scene server 1620 transmits a check response.

The scene server 1620 transmits the check response to the matching room function server 1640, indicating that the validity check of the account name succeeds.

Operation 1718: The matching room function server 1640 transmits a room data notification.

In a case that a rival game team is matched, and the game process is about to proceed to the battle loading process from the battle preparation process, the matching room function server 1640 transmits the room data notification to the scene server 1620.

Operation 1719: The scene server 1620 transmits the room data notification.

The scene server 1620 transmits the room data notification to the client 1610 after receiving the room data notification transmitted by the matching room function server 1640.

Operation 1720: The matching room function server 1640 synchronizes the team soul card data of the game team.

In a case that the rival game team is matched, and the game process is about to proceed to the battle loading process from the battle preparation process, the matching room function server 1640 synchronizes the team soul card data of the game team to a room server 1650, including the team account name and appearance information of each game account.

Operation 1721: The room server 1650 saves the team soul card data of the game team.

The room server 1650 receives the team soul card data of the game team transmitted by the matching room function server 1640, and then performs a saving operation on the team soul card data of the game team.

Operation 1722: The room server 1650 transmits team soul card deduction information.

After the battle fight process in the game process ends, the room server 1650 transmits a message of deducting the team soul card to the scene server 1620. In this case, team soul card data that has been used in this battle is cleared.

Based on the above, through the method provided in this embodiment, after the team soul card is set in the battle preparation process or in a case of being not in a game process, to support a first game account to use the team soul card, the team account name of each game account and the appearance information of each game account are displayed on a player slot corresponding to each game account in the game team. In this way, interactive behavior costs and communication costs are reduced, and a group atmosphere of the game team is enhanced, thereby improving user experience, and improving team cooperation skills.

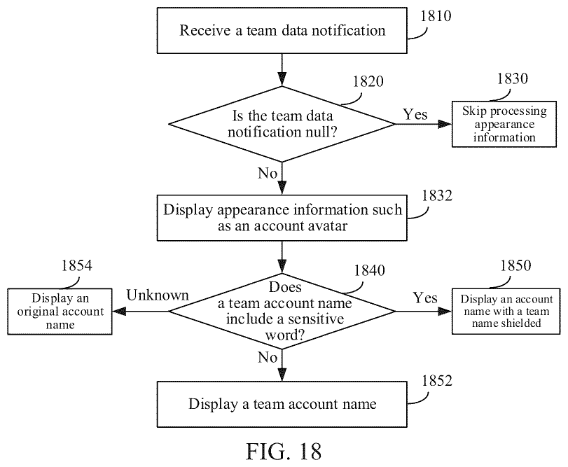

FIG. 18 is a flowchart of a team appearance changing method according to an exemplary embodiment of this application. The method is performed by a client and a scene server, and includes the following operations:

Operation 1810: A client receives a team data notification.

The client receives the team data notification transmitted by a scene server. The team data notification includes each team account name and appearance information of each game account. The team account name is an account name with a team name and an interpunct added before the account name. The appearance information includes at least one of an account avatar, an account avatar frame, and an account flag.

Operation 1820: The client determines whether the team data notification is null.

The client determines whether the team data notification is null. In a case that the game team data notification is null, operation 1830 is performed. In a case that the game team data notification is not null, operation 1832 is performed.

Operation 1830: The client does not process appearance information.

In a case that the team data notification is null, i.e., a team soul card is not used, the client does not process the appearance information, and displays original appearance information of each game account.

Operation 1832: The client displays the appearance information such as an account avatar.

In a case that the game team data notification is not null, i.e., the team soul card is used, the client displays the appearance information such as the account avatar, the account avatar frame, and the account flag.

Operation 1840: A scene server determines whether a team account name includes a sensitive word.

The scene server checks the team account name, to determine whether the team account name includes the sensitive word. In a case that the team account name includes the sensitive word, operation 1850 is performed. In a case that the team account name does not include the sensitive word, operation 1852 is performed. In a case that it cannot be determined whether the team account name includes the sensitive word, operation 1854 is performed. The sensitive word is a word set in the scene server that cannot be used in the account name.

Operation 1850: The client displays an account name with a team name shielded.

In a case that the team account name includes the sensitive word, the client displays the account name with the team name shielded. Exemplarily, a team account name of a game account B is Amen•game account B, and a sensitive word in a game system includes men B. The client uses asterisks to shield the team name, and finally displays the team account name of **•game account B.

Operation 1852: The client displays the team account name.

In a case that the team account name does not include the sensitive word, the client displays the team account name based on an established rule. Exemplarily, an original account name of a game account A is game account A, and a team account name is Amen•game account A, men A being not the sensitive word in the game system. The client finally displays the team account name of Amen•game account A.

Operation 1854: The client displays an original account name.

During the determining of whether the team account name is the sensitive word by the scene server, a result of the determining is destroyed before being transmitted due to reasons such as a network fluctuation, resulting in that the client cannot determine whether the team account name includes the sensitive word. In this case, the client displays the original account name. Exemplarily, the original account name of the game account A is game account A, and the team account name is Amen•game account A. The client cannot determine whether the Amen•game account A includes the sensitive word, and therefore the client finally displays the team account name of game account A.

Based on the above, through the method provided in this embodiment, after the team soul card is set in the battle preparation process or in a case of being not in a game process, to support a first game account to use the team soul card, the team account name of each game account and the appearance information of each game account are displayed on a player slot corresponding to each game account in the game team. In this way, interactive behavior costs and communication costs are reduced, and a group atmosphere of the game team is enhanced, thereby improving team cooperation skills.

According to the method provided in this embodiment, the determining of whether the team account name includes the sensitive word is performed and processed, and the team account name of each game account is displayed without violating relevant regulations. In this way, interactive behavior costs and communication costs are reduced, and a group atmosphere of the game team is enhanced, thereby improving user experience, and improving team cooperation skills.

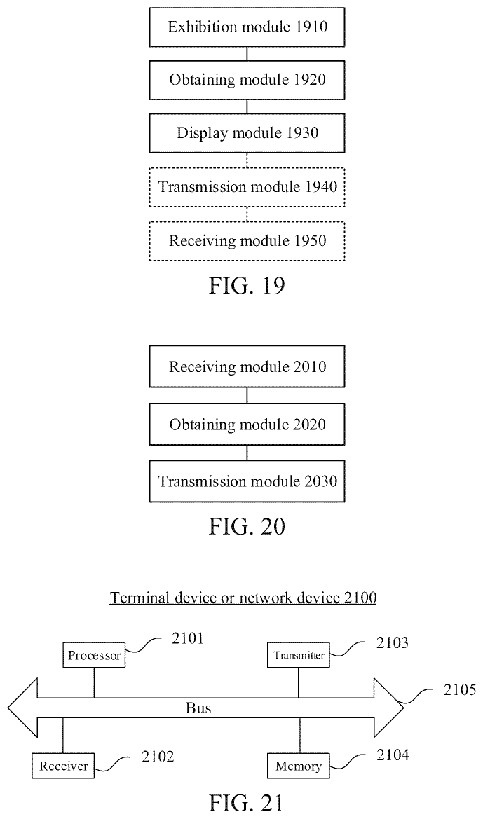

FIG. 19 is a block diagram of a team appearance changing apparatus according to an exemplary embodiment of this application. The apparatus includes:

an exhibition module 1910, configured to display a team exhibition interface of a game team, the team exhibition interface including a plurality of player slots belonging to the game team;

an obtaining module 1920, configured to display appearance information of each game account in the game team on the plurality of player slots; and

a display module 1930, configured to display, in response to a first game account of each game account in the game team using a first function, unified appearance information related to the first function on a player slot corresponding to each game account.

In an exemplary implementation, the display module 1930 is configured to replace the appearance information of each game account with the same first appearance information for display on the player slot corresponding to the game account in response to the first game account of each game account using the first function.

The appearance information includes at least one of an account avatar, an account flag, an account avatar frame, an account role frame, a background picture, and a birth mark.

In an exemplary implementation, the display module 1930 is configured to: replace the appearance information of each game account with the same first appearance information for display on the player slot corresponding to the game account in response to the first game account of each game account using a first item; or

replace the appearance information of each game account with the same first appearance information for display on the player slot corresponding to the game account in response to the first game account of each game account using a first skill.

The first appearance information is determined by a server authorized to use information in at least one of the following manners:

obtaining setting information of the first game account for the first function, and determining the first appearance information based on appearance information preset by the server in a case that the setting information is blank information;

obtaining the setting information of the first game account for the first function, and determining the first appearance information based on the setting information in a case that the setting information is not the blank information;

obtaining personal attribute information of the first game account, identifying, from the personal attribute information, a quantity of times the appearance information has been used, and determining the first appearance information based on the appearance information that has been used a maximum quantity of times; and obtaining the personal attribute information of the first game account, identifying a usage time of the appearance information from the personal attribute information, and determining the first appearance information based on the appearance information with a longest usage time.

In an exemplary implementation, the display module 1930 is configured to display unified appearance information related to the first function on a player slot corresponding to each game account in the game team in response to the first game account of each game account using the first function in a battle preparation process.

In an exemplary implementation, the display module 1930 is configured to display unified appearance information related to the first function on the player slot corresponding to each game account in the game team in response to the first game account of each game account using the first function in a battle loading process.

In an exemplary implementation, the display module 1930 is configured to display unified appearance information related to the first function on the player slot corresponding to each game account in the game team in response to the first game account of each game account using the first function in a battle fight process.

In an exemplary implementation, the display module 1930 is configured to display a team account name of each game account on the player slot corresponding to each game account in the game team in response to the first game account of each game account using the first function,

the team account name being a combination of the same team name and the account name of the game account, and the team name being a name set by using the first function.

In an exemplary implementation, the apparatus further includes: a transmission module 1940, configured to transmit the appearance information of each game account to the server.

In an exemplary implementation, the apparatus further includes: a receiving module 1950, configured to receive the first appearance information returned by the server, the first appearance information being obtained by the server based on the appearance information by using an appearance information generation model.

In an exemplary implementation, the appearance information generation model is trained in the following manners:

obtaining sample appearance information of a sample game team, the sample appearance information including at least one of account avatars of at least two sample accounts, a team name of the sample game team, an account name of the sample account, and a team profile of the sample game team, the at least two sample accounts including a first sample account;

inputting the sample appearance information into an image processing model, to obtain the first appearance information;

calculating an error loss between the first appearance information and appearance information actually used by the sample game team; and

training the image processing model based on the error loss, to obtain the appearance information generation model.

FIG. 20 is a block diagram of a team appearance changing apparatus according to an exemplary embodiment of this application. The apparatus includes:

a receiving module 2010, configured to receive a request message transmitted by a terminal to which a first game account is logged in, the request message being configured for requesting to unify appearance information of game accounts in a game team, the request message being transmitted by the terminal in a case that the first game account uses a first function, and the first game account being one of the game accounts;

an obtaining module 2020, configured to query for or generate first appearance information of the game team based on the request message, the first appearance information being displayed as unified appearance information on a player slot corresponding to each game account in the game team; and

a transmission module 2030, configured to transmit the first appearance information of the game team to the terminal.

In an exemplary implementation, the obtaining module 2020 is configured to: query for, based on the request message, the first appearance information of the game team preset by the first game account; or

generate the first appearance information of the game team based on the request message by using an appearance information generation model.

In an exemplary implementation, the obtaining module 2020 is configured to: obtain the appearance information of each game account in the game team based on the request message; and

input the appearance information into the appearance information generation model, to generate the first appearance information of the game team.

In an exemplary implementation, the appearance information generation model is trained in the following manners:

obtaining sample appearance information of a sample game team, the sample appearance information including at least one of account avatars of at least two sample accounts, a team name of the sample game team, an account name of the sample account, and a team profile of the sample game team, the at least two sample accounts including a first sample account;

inputting the sample appearance information into an image processing model, to obtain the first appearance information;

calculating an error loss between the first appearance information and appearance information actually used by the sample game team; and

training the image processing model based on the error loss, to obtain the appearance information generation model.

FIG. 21 is a schematic structural diagram of a terminal device or a network device 2100 according to an exemplary embodiment of this application. The terminal device or the network device includes a processor 2101, a receiver 2102, a transmitter 2103, a memory 2104, and a bus 2105.

The processor 2101 includes one or more processing cores. The processor 2101 executes various function applications and performs information processing by running software programs and modules.

The receiver 2102 and the transmitter 2103 may be implemented as a communication component. The communication component may be a communication chip, and may be referred to as a transceiver.

The memory 2104 is connected to the processor 2101 through the bus 2105.

The memory 2104 may be configured to store at least one instruction. The processor 2101 is configured to execute the at least one instruction, to implement the operations in the foregoing method embodiments.

In addition, the memory 2104 may be implemented by any type of volatile or non-volatile storage device or a combination thereof. The volatile storage device or the non-volatile storage device includes but is not limited to a magnetic disk or an optical disc, an electrically erasable programmable read only memory (EEPROM), an EPROM, a static random access memory (SRAM), a ROM, a magnetic memory, a flash memory, and a PROM.

In a possible implementation, the processor of the terminal device is configured to: display a team exhibition interface of a game team, the team exhibition interface including a plurality of player slots belonging to the game team;

display appearance information of each game account in the game team on the plurality of player slots; and

display, in response to a first game account of each game account in the game team using a first function, unified appearance information related to the first function on a player slot corresponding to each game account.

The transceiver of the terminal device is configured to: transmit appearance information of each game account to a server; and

receive first appearance information returned by the server, the first appearance information being obtained by the server based on the appearance information by using an appearance information generation model.

In a possible implementation, the transceiver of the network device is configured to receive a request message transmitted by a terminal to which a first game account is logged in, the request message being configured for requesting to unify appearance information of game accounts in a game team, the request message being transmitted by the terminal in a case that the first game account uses a first function, and the first game account being one of the game accounts;

The processor of the network device is configured to query for or generate first appearance information of the game team based on the request message, the first appearance information being displayed as unified appearance information on a player slot corresponding to each game account in the game team.

The transceiver of the network device is configured to transmit the first appearance information of the game team to the terminal.

In an exemplary embodiment, a non-transitory computer-readable storage medium is further provided, having at least one instruction, at least one program, a code set, or an instruction set stored therein, the at least one instruction, the at least one program, the code set, or the instruction set being loaded and executed by a processor, to implement the team appearance changing method in the foregoing method embodiments.

In an exemplary embodiment, a computer program product is further provided, the computer program product, when run on a processor, causing a terminal device or a network device to perform the team appearance changing method in the foregoing method embodiments. The term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A team appearance changing method performed by a computer device, the method comprising:
displaying a team exhibition interface, the team exhibition interface comprising a plurality of player slots corresponding to a plurality of players belonging to a game team;
displaying appearance information of the plurality of players in the game team on the plurality of player slots, wherein different players have different appearance information; and
in response to a first player using a first function, displaying unified appearance information related to the first function on the plurality of player slots in replacement of the different appearance information corresponding to the plurality of players in the game team.

2. The method according to claim 1, wherein the displaying unified appearance information related to the first function on the plurality of player slots in replacement of the different appearance information corresponding to the plurality of players in the game team comprises:
replacing the appearance information of each of the plurality of players with same first appearance information for display on the player slot corresponding to the player in response to the first player using the first function,
the appearance information comprising at least one of an account avatar, an account flag, an account avatar frame, an account role frame, a background picture, and a birth mark.

3. The method according to claim 2, wherein the replacing the appearance information of each of the plurality of players with same first appearance information for display on the player slot corresponding to the player in response to the triggering of the first function comprises:
replacing the appearance information of each of the plurality of players with the same first appearance information for display on the player slot corresponding to the player in response to the first game account using a first item; or
replacing the appearance information of each of the plurality of players with the same first appearance information for display on the player slot corresponding to the player in response to the first game account using a first skill.

4. The method according to claim 2, wherein the first appearance information is determined by a server authorized to use information in at least one of the following manners:
obtaining setting information of the first player for the first function, and determining the first appearance information based on appearance information preset by the server when the setting information is blank information;
obtaining the setting information of the first player for the first function, and determining the first appearance information based on the setting information when the setting information is not the blank information;
obtaining personal attribute information of the first player, identifying, from the personal attribute information, a quantity of times the appearance information has been used, and determining the first appearance information based on the appearance information that has been used a maximum quantity of times; and
obtaining the personal attribute information of the first player, identifying a usage time of the appearance information from the personal attribute information, and determining the first appearance information based on the appearance information with a longest usage time.

5. The method according to claim 2, wherein the method further comprises:
transmitting the appearance information of each player to a server; and
receiving the first appearance information returned by the server using an appearance information generation model based on the appearance information.

6. The method according to claim 5, wherein the appearance information generation model is trained in the following manners:
obtaining sample appearance information of a sample game team, the sample appearance information comprising at least one of account avatars of at least two sample accounts, a team name of the sample game team, an account name of the sample account, and a team profile of the sample game team, the at least two sample accounts comprising a first sample account;
inputting the sample appearance information into an image processing model, to obtain the first appearance information;
calculating an error loss between the first appearance information and appearance information actually used by the sample game team; and
training the image processing model based on the error loss, to obtain the appearance information generation model.

7. The method according to claim 1, wherein the displaying unified appearance information related to the first function on the plurality of player slots in replacement of the different appearance information corresponding to the plurality of players in the game team comprises at least one of the following:
displaying the unified appearance information related to the first function on the player slot corresponding to each player in response to the player using the first function in a battle preparation process;
displaying the unified appearance information related to the first function on the player slot corresponding to each player in response to the player using the first function in a battle loading process; and
displaying the unified appearance information related to the first function on the player slot corresponding to each player in response to the player using the first function in a battle fight process.

8. The method according to claim 1, further comprising:
displaying a team account name of each player on the player slot corresponding to the player in response to the first player using the first function,
the team account name being a combination of a same team name and the account name of the player, the team name being a name set by using the first function.

9. A computer device, comprising:
a processor;
a transceiver connected to the processor; and
a memory, configured to store executable instructions of the processor, the processor being configured to load and execute the executable instructions to implement a team appearance changing method including:
displaying a team exhibition interface, the team exhibition interface comprising a plurality of player slots corresponding to a plurality of players belonging to a game team;
displaying appearance information of the plurality of players in the game team on the plurality of player slots, wherein different players have different appearance information; and
in response to a first player using a first function, displaying unified appearance information related to the first function on the plurality of player slots in replacement of the different appearance information corresponding to the plurality of players in the game team.

10. The computer device according to claim 9, wherein the displaying unified appearance information related to the first function on the plurality of player slots in replacement of the different appearance information corresponding to the plurality of players in the game team comprises:
replacing the appearance information of each of the plurality of players with same first appearance information for display on the player slot corresponding to the player in response to the first player using the first function,
the appearance information comprising at least one of an account avatar, an account flag, an account avatar frame, an account role frame, a background picture, and a birth mark.

11. The computer device according to claim 10, wherein the replacing the appearance information of each of the plurality of players with same first appearance information for display on the player slot corresponding to the player in response to the triggering of the first function comprises:
replacing the appearance information of each of the plurality of players with the same first appearance information for display on the player slot corresponding to the player in response to the first game account using a first item; or
replacing the appearance information of each of the plurality of players with the same first appearance information for display on the player slot corresponding to the player in response to the first game account using a first skill.

12. The computer device according to claim 10, wherein the first appearance information is determined by a server authorized to use information in at least one of the following manners:
obtaining setting information of the first player for the first function, and determining the first appearance information based on appearance information preset by the server when the setting information is blank information;
obtaining the setting information of the first player for the first function, and determining the first appearance information based on the setting information when the setting information is not the blank information;
obtaining personal attribute information of the first player, identifying, from the personal attribute information, a quantity of times the appearance information has been used, and determining the first appearance information based on the appearance information that has been used a maximum quantity of times; and
obtaining the personal attribute information of the first player, identifying a usage time of the appearance information from the personal attribute information, and determining the first appearance information based on the appearance information with a longest usage time.

13. The computer device according to claim 10, wherein the method further comprises:
transmitting the appearance information of each player to a server; and
receiving the first appearance information returned by the server using an appearance information generation model based on the appearance information.

14. The computer device according to claim 13, wherein the appearance information generation model is trained in the following manners:
obtaining sample appearance information of a sample game team, the sample appearance information comprising at least one of account avatars of at least two sample accounts, a team name of the sample game team, an account name of the sample account, and a team profile of the sample game team, the at least two sample accounts comprising a first sample account;
inputting the sample appearance information into an image processing model, to obtain the first appearance information;
calculating an error loss between the first appearance information and appearance information actually used by the sample game team; and
training the image processing model based on the error loss, to obtain the appearance information generation model.

15. The computer device according to claim 9, wherein the displaying unified appearance information related to the first function on the plurality of player slots in replacement of the different appearance information corresponding to the plurality of players in the game team comprises at least one of the following:
displaying the unified appearance information related to the first function on the player slot corresponding to each player in response to the player using the first function in a battle preparation process;
displaying the unified appearance information related to the first function on the player slot corresponding to each player in response to the player using the first function in a battle loading process; and
displaying the unified appearance information related to the first function on the player slot corresponding to each player in response to the player using the first function in a battle fight process.

16. The computer device according to claim 9, wherein the method further comprises:
displaying a team account name of each player on the player slot corresponding to the player in response to the first player using the first function,
the team account name being a combination of a same team name and the account name of the player, the team name being a name set by using the first function.

17. A non-transitory computer-readable storage medium, having a computer program stored therein, the computer program being loaded and executed by a processor of a computer device and causing the computer device to implement a team appearance changing method including:
displaying a team exhibition interface, the team exhibition interface comprising a plurality of player slots corresponding to a plurality of players belonging to a game team;
displaying appearance information of the plurality of players in the game team on the plurality of player slots, wherein different players have different appearance information; and
in response to a first player using a first function, displaying unified appearance information related to the first function on the plurality of player slots in replacement of the different appearance information corresponding to the plurality of players in the game team.

18. The non-transitory computer-readable storage medium according to claim 17, wherein the displaying unified appearance information related to the first function on the plurality of player slots in replacement of the different appearance information corresponding to the plurality of players in the game team comprises:
replacing the appearance information of each of the plurality of players with same first appearance information for display on the player slot corresponding to the player in response to the first player using the first function,
the appearance information comprising at least one of an account avatar, an account flag, an account avatar frame, an account role frame, a background picture, and a birth mark.

19. The non-transitory computer-readable storage medium according to claim 17, wherein the displaying unified appearance information related to the first function on the plurality of player slots in replacement of the different appearance information corresponding to the plurality of players in the game team comprises at least one of the following:
displaying the unified appearance information related to the first function on the player slot corresponding to each player in response to the player using the first function in a battle preparation process;
displaying the unified appearance information related to the first function on the player slot corresponding to each player in response to the player using the first function in a battle loading process; and
displaying the unified appearance information related to the first function on the player slot corresponding to each player in response to the player using the first function in a battle fight process.

20. The non-transitory computer-readable storage medium according to claim 17, wherein the method further comprises:
displaying a team account name of each player on the player slot corresponding to the player in response to the first player using the first function,
the team account name being a combination of a same team name and the account name of the player, the team name being a name set by using the first function.
